(19) United States
(12) Patent Application Publication
(10) Pub. No.: US 2026/0048663 A1
(43) Pub. Date: Feb. 19, 2026

(54) METHODS AND SYSTEMS FOR COORDINATED CONTROL OF ONE OR MORE RECREATIONAL VEHICLE ENTERTAINMENT SYSTEMS

(71) Applicant: Red Weather Systems Inc., Costa Mesa, CA (US)

(72) Inventor: Trent Farrer, Sandy, OR (US)

(21) Appl. No.: 19/100,502

(22) PCT Filed: Aug. 2, 2023
(86) PCT No.: PCT/US2023/071542

§ 371 Date: Jan. 31, 2025

Related U.S. Application Data
(60) Provisional application No. 63/370,431, filed on Aug. 4, 2022.

(51) Int. Cl. B60K 35/81; H04N 21/414; H04N 21/6371

(52) U.S. Cl. CPC B60K 35/81; H04N 21/41422; H04N 21/6371; B60K 2360/184

(57) ABSTRACT

Methods and systems are provided for control of multiple entertainment systems. In one example, a method comprises communicatively connecting a central control hub of a first entertainment system to one or more display devices of a second entertainment system; and actuating the one or more display devices of the second entertainment system via the central control hub. The first entertainment system and the second entertainment system may be recreational vehicle (RV) entertainment systems. The one or more display devices may include one or more of a water device, a fire device, a lighting device, a camera, and an audio device, for example.

### CROSS REFERENCE TO RELATED APPLICATIONS

The present application claims priority to U.S. Provisional Application No. 63/370,431 entitled “METHODS AND SYSTEMS FOR COORDINATED CONTROL OF ONE OR MORE RECREATIONAL VEHICLE ENTERTAINMENT SYSTEMS” filed Aug. 4, 2022. The entire contents of the above identified application is hereby incorporated by reference for all purposes.

### FIELD

The present description relates generally to methods and systems for coordinated control of one or more entertainment systems. Each of the one or more entertainment systems may be recreational vehicle (RV) entertainment systems. Such one or more entertainment systems may include display devices such as fire devices, water devices, audio devices, and visual devices such as lighting devices and cameras. Coordinated control of the one or more entertainment systems may be provided via a central control hub.

### BACKGROUND/SUMMARY

Entertainment systems may include one or more display devices with audio and/or visual capabilities. In one example, an entertainment system may be used to generate a desired atmosphere for a gathering. For example, at gatherings such as sporting events, camping trips, social gatherings, holiday parties, etc., one or more entertainment systems may provide visual performances via lighting, fire, and/or water displays, which may be synchronized to music. In some cases, the one or more entertainment systems may be RV entertainment systems. Thus, the one or more entertainment systems may enhance an aesthetic and sensory enjoyment of the RV environment, including both the environment inside the RV and outside the RV.

There may be cases where it is desirable to coordinate control across multiple entertainment systems. For example, there may be multiple RVs at an event, each with its own corresponding RV entertainment system. Coordinating control across these multiple RV entertainment systems may thus be desirable to support the creation of an entertainment experience across the multiple RVs. For example, it may be desired to coordinate one or more of an audio output and fire display across the multiple RV entertainment systems. However, signal management across the multiple RV entertainment systems presents challenges. For example, a failure to properly coordinate signals for an audio output across the multiple RV entertainment systems may lead to an asynchronous output, degrading the entertainment experience.

Along with challenges that may arise in signal management for one or more of the entertainment systems, there may be further challenges in the management of additional systems, such as a security system, for example.

In one example, the issues described above may be at least partially addressed by methods and systems for operating one or more entertainment systems. The methods may comprise receiving user input at a first central control hub communicatively coupled to one or more display devices of a first entertainment system, the user input including instructions for operating the first entertainment system in a party mode. Responsive to receiving the user input, the first entertainment system may be controlled to operate in a party mode such that the one or more display devices of the first entertainment system and one or more display devices of a second entertainment system are actuatable via the first central control hub. In one or more examples, the first entertainment system may be associated with a first RV and the second entertainment system may be associated with a second RV.

The method further includes converting the instructions into one or more signal transmission modes at the first central control hub, the one or more signal transmission modes corresponding to communication modes of the one or more display devices of the first entertainment system and the one or more display devices of the second entertainment system. The instructions may be delivered to output a display at the one or more display devices of the first entertainment system and the one or more display devices of the second entertainment system, the display including visual and/or audio displays, based on the instruction. In this way, devices of multiple entertainment systems may be controlled in a coordinated manner.

For example, the one or more display devices of the entertainment system may be controlled in a unified manner based on a capability of the first central control hub for receiving and transmitting signals via different communication modes or protocols. The first central control hub may be configured to facilitate coordinated operation of the display devices according to the user input, which may be received via one or more input modes. Additionally, the first central control hub may communicate with a database to deliver pre-set instructions for operating the display devices, thereby providing flexibility with respect to how much user input is demanded, as desired by a user. The pre-set instructions may include an entertainment program or other custom pre-sets, such as a sports mode in which a projector is controlled to turn on the sports channel, for example.

Furthermore, the first central control hub may further be able to interpret one or more signals received from the one or more devices of the first entertainment system and/or the one or more devices of the second entertainment system to provide and provide an output. For example, the first central control hub may provide a security alert responsive to one or more cameras providing a signal as to detecting an object and/or body. The security alert may comprise one or more of visual and/or audio signals being sent for display via the first central control hub. For example, a recording of the detected object and/or body may be sent. Notably, in the party mode, the security alert may be provided to an entertainment system different than the entertainment system to which the camera belongs.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example of an environment in which an entertainment system may be located and operated, the entertainment system including a central control hub.

FIG. 2 shows a first view of a first exemplary embodiment of a central control hub.

FIG. 3 shows a second view of the central control hub of FIG. 2.

FIG. 4 shows a second exemplary embodiment of a central control hub.

FIG. 5 shows a third exemplary embodiment of a central control hub.

FIG. 6 shows a fourth exemplary embodiment of a central control hub.

FIG. 7 shows a fifth exemplary embodiment of a central control hub.

FIG. 8 shows a diagram depicting signal flow in a network of the entertainment system.

FIG. 9 shows an example of a method for operating the entertainment system.

FIG. 10 shows a second example environment in which an entertainment system may be located and operated, the entertainment system including a central control hub.

FIG. 11 shows a second example method for operating the entertainment system.

FIG. 12 shows a third example environment in which an entertainment system may be located and operated, including a first central control hub and a second central control hub.

FIG. 13A shows a connectivity map for multiple entertainment systems operated in a first mode.

FIG. 13B shows a connectivity map for multiple entertainment systems operated in a second mode.

FIG. 14 shows an example of a method for operating one or more entertainment systems.

FIG. 15 shows an example of a method for pairing multiple entertainment systems.

FIG. 16 shows example lantern lighting devices.

FIG. 17A shows an example torch configuration.

FIG. 17B shows further detail of the torch configuration of FIG. 17A.

FIG. 17C shows a carrying case for the torch configuration of FIG. 17A-17B.

### DETAILED DESCRIPTION

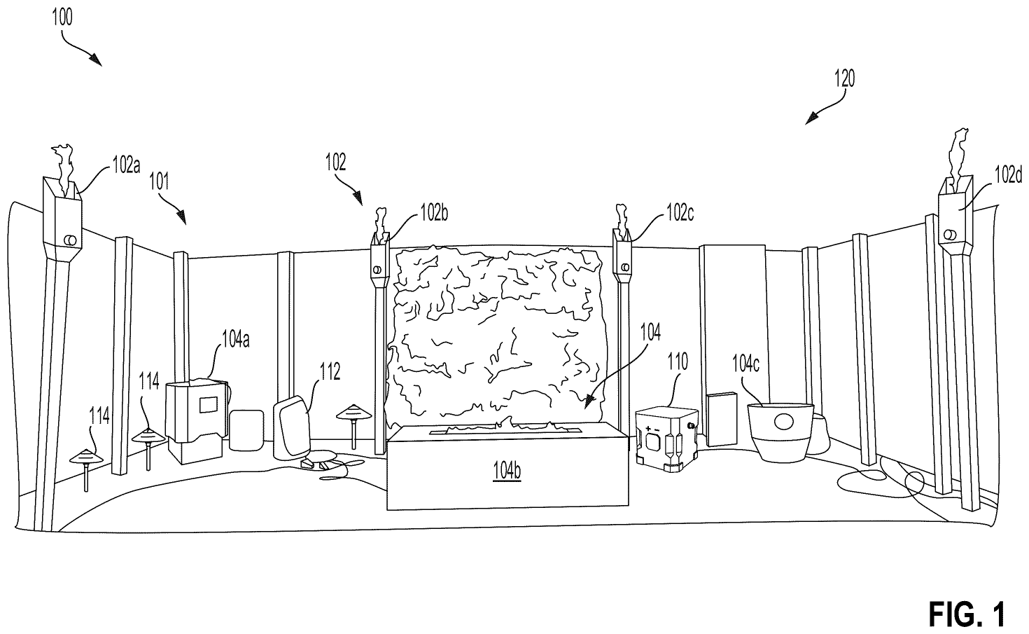

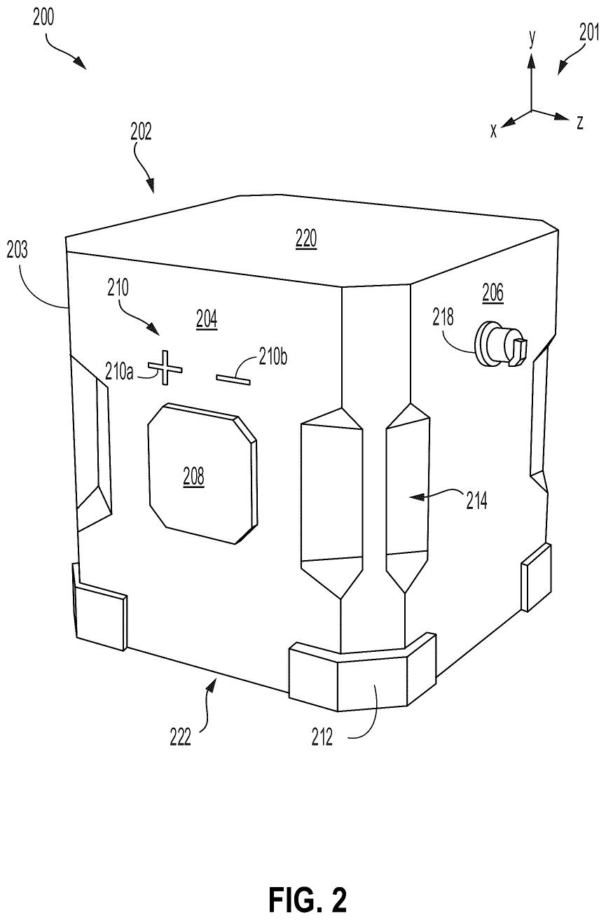

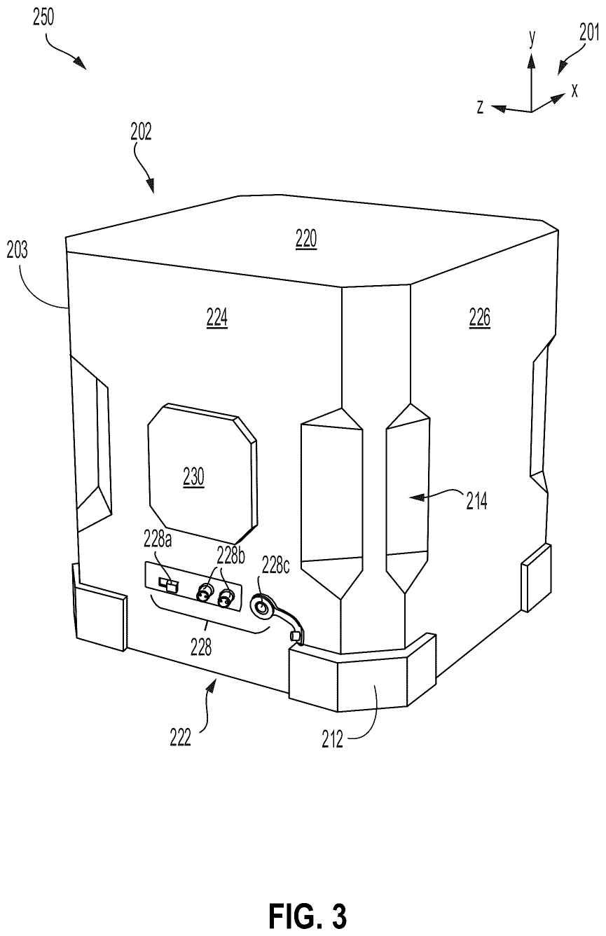

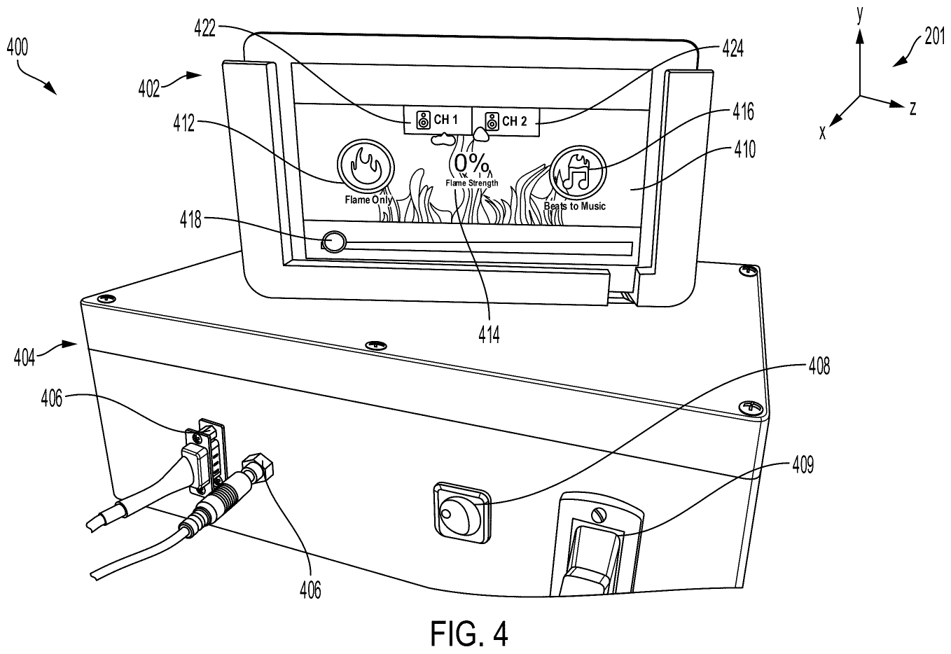

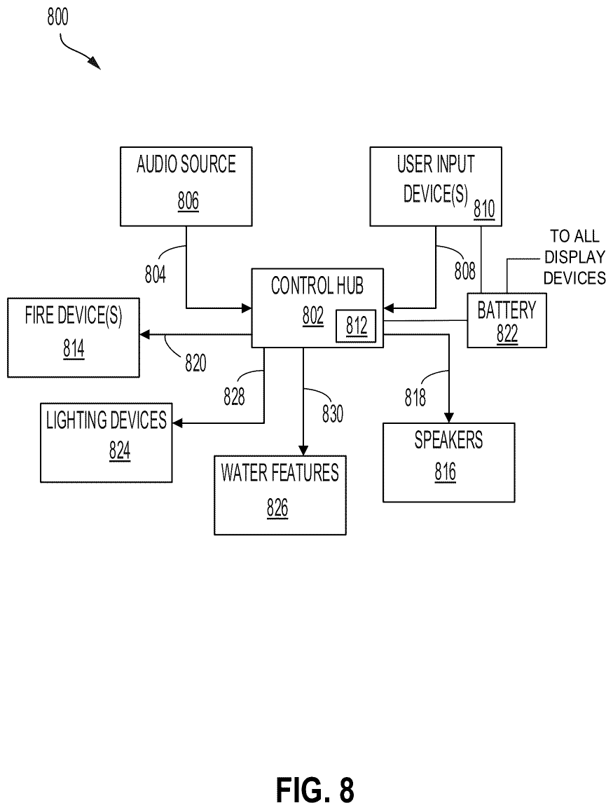

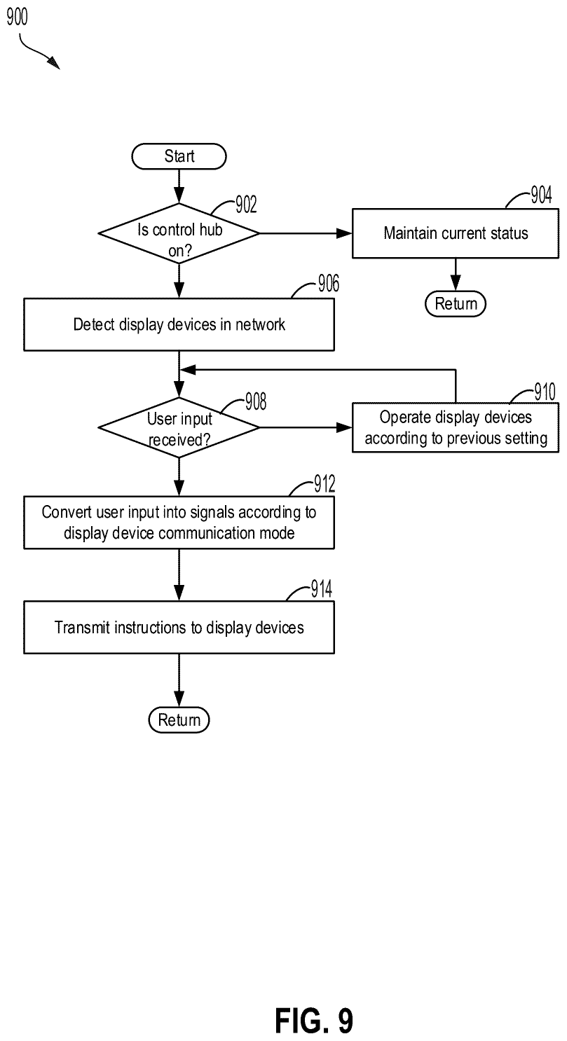

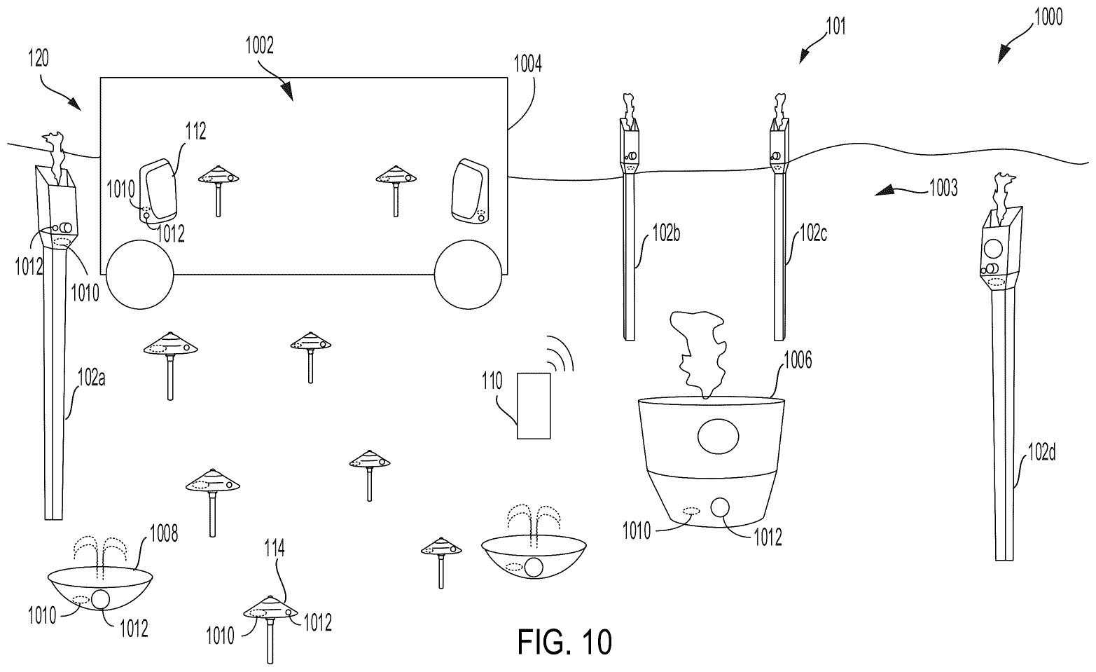

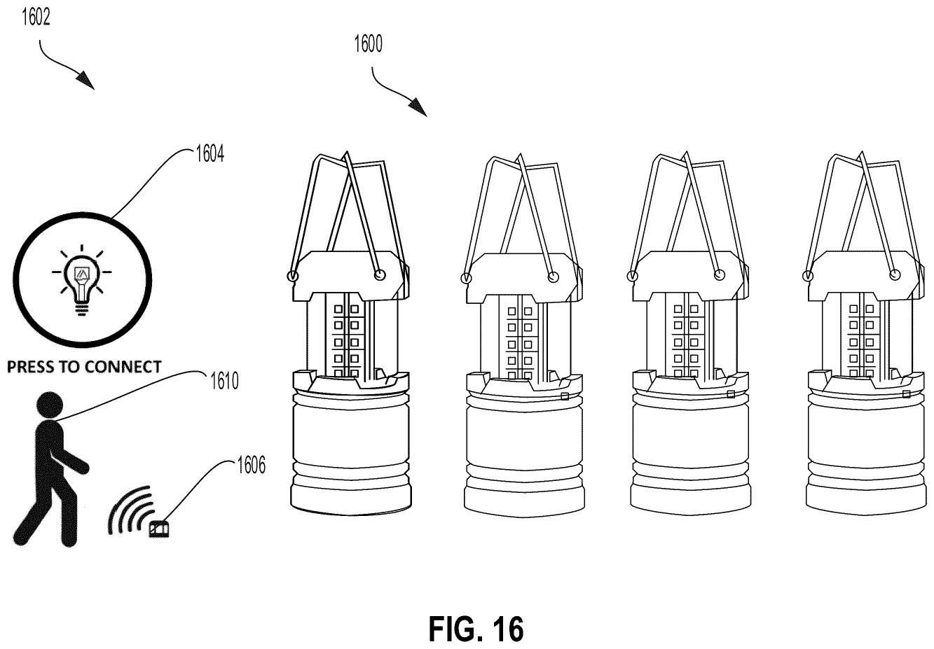

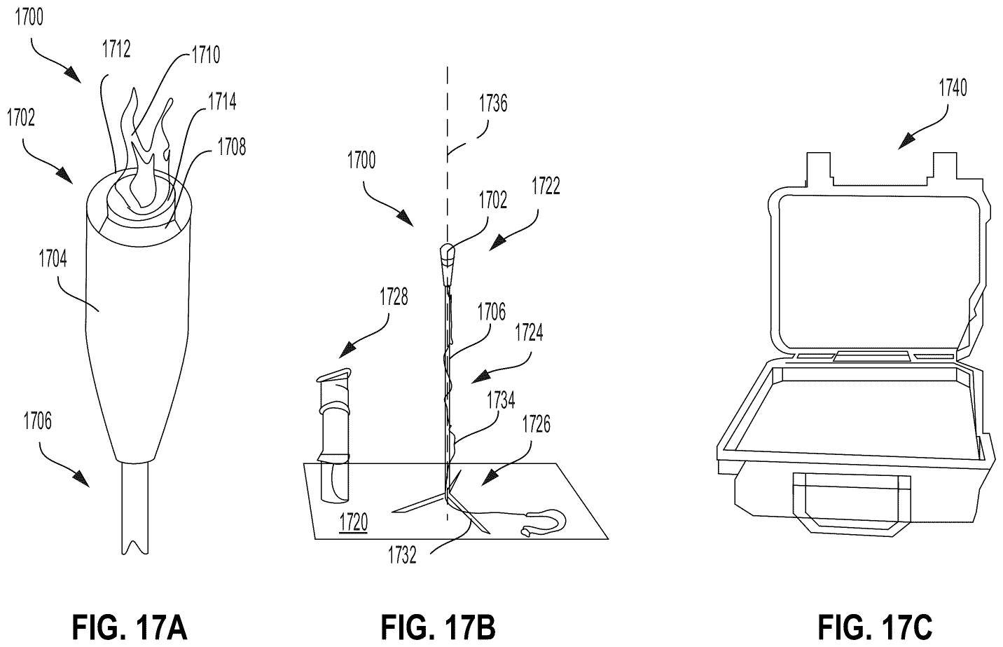

The following description relates to systems and methods for an entertainment system. The entertainment system may include one or more display devices providing visual and/or audio presentations. The display devices may be included in a network of the entertainment system, which may be installed in a variety of environments. For example, the entertainment system may be displayed in indoor settings, such as a warehouse, as shown in FIG. 1, as well as outdoor settings, such as backyards, courtyards, etc. In some examples, the entertainment system may be displayed in a system environment that includes both indoor and outdoor components, such as shown in FIG. 10. In order to provide efficient, concerted control of the network of display devices, a central control hub may be implemented in the entertainment system. A first example of the central control hub is shown in FIGS. 2-3, and additional examples of the central control hub are depicted in FIGS. 4-7. A diagram is shown in FIG. 8, illustrating transmission of signals between components of the network of the entertainment system, where the network includes different types of display devices as well as the central control hub. Operation of the entertainment system(s) is depicted in FIGS. 9, 11, and 14-15, in example methods for controlling operating parameters of the devices. Example display devices, including example lantern lighting devices and an example torch configuration are shown at FIGS. 16-17B. FIG. 17C shows a carrying case that may be used to house and charge a torch of FIGS. 17A-17B.

Turning first to FIG. 1, it shows a system environment 100, according to one or more examples of the present disclosure. The system environment 100 is the environment in which devices of the present disclosure on a same network are located.

The system environment 100 in FIG. 1 is depicted as an indoor environment, in particular a large warehouse space. Indoor environments for the system environment 100 may additionally or alternatively include one or more of inside a residential building, inside a commercial building, inside a recreational vehicle (RV), inside a tent, and inside a cabin of a boat, for example. It is noted that other indoor environments may be possible without departing from the scope of the present disclosure. In other examples, the system environment 100 may instead be an outdoor environment, such as a backyard, a campsite, on deck of a boat, or on a body of water such as a lake or ocean, for example. In at least one example, the system environment 100 may comprise one or more indoor environments and one or more outdoor environments. For example, the system environment 100 may include the indoor environment of inside an RV as well as the outdoor environment of a campsite (such as shown at FIG. 10). As another example, the system environment 100 may include the indoor environment of inside a residential building (e.g., a house), as well as the outdoor environment of a backyard. In a further example, the system environment 100 may include the indoor environment of inside a tent, as well as the outdoor environment of on deck of a boat and on a lake. In such examples where the system environment 100 includes on a lake, at least one device in the network is positioned on the lake, such as a speaker with its own flotation configuration.

The system environment 100 includes a network 101 of visual and audio display devices which may be included in an entertainment system 120. As discussed in further detail at FIG. 10, each of the devices in the network 101 may comprise a network-based controller and a connect mode input. The connect mode input may be a connect mode button, dial, or other user input provided on each of the visual and audio display devices of the entertainment system 120 to initiate connection of the devices to the network 101.

In one example, as shown in FIG. 1, the entertainment system 120 may include fire devices as visual display devices, the fire devices including a plurality of torches 102a, 102b, 102c, 102d (also referred to as torches 102). Though there are four torches (e.g., fire torches) shown in the example at FIG. 1, it is noted that additional torches or fewer torches may be included in the system without departing from the scope of the disclosure. One or more of the torches 102 may be fire only devices, in at least one example. That is, one or more of the torches 102 may provide a fire display without providing an audio output. It is further noted that one or more of the torches 102 may provide both a fire display and an audio output, in at least one example. In such examples, the one or more fire pits 104 providing the audio output may be considered combination audio and visual display devices.

Moreover, as shown at FIG. 17A, in one or more examples a torch configuration 1700 may be collapsible such that the torches are able to be stored in a carrying case. Torch configuration 1700 may be one, more, or all of torches 102 shown in FIG. 1, such as torches 102a, 102b, 102c, and/or 102d. The torch configuration 1700 may include a torch head 1702 mounted to a pole extension 1706. The torch head 1702 may comprise a housing 1704 about a burner 1708. The housing 1704 may comprise a first open 1712 that may be located about the burner 1708. The burner 1708 may produce a flame 1710 that may be positioned above the burner 1708. The burner 1708 may be fluidly coupled to the pole extension 1706, such that gas traveling through the pole extension 1706 may leave through and be ignited by the burner 1708 to produce the flame 1710. The burner 1708 may comprise a second opening 1714 that may feed the flame 1710 with gas.

Turning briefly to FIG. 17B, it shows the torch configuration 1700 resting upon a surface 1720 may be comprised of a first section 1722, a second section 1724, and a third section 1726. The torch configuration 1700 may be collapsible and may be stored in a pole and stand bag 1728. The first section 1722 may comprise the torch head 1702. The third section 1726 may comprise a base 1732, such as a tripod, that may be collapsible. The base 1732 may stand the pole extension 1706 upright such that the torch configuration 1700 may be approximately parallel to an axis 1736 normal to the surface 1720. A wire 1734 may extend from the base 1732, about the pole extension 1706, and to the torch head 1702. The wire 1734 may electrically couple to the torch head 1702, such that the ignitor of a burner, such as the burner 1708, may be supplied with electricity. Likewise, the wire 1734 may electrically couple to other components of the torch configuration 1700, such as the pole extension 1706.

Turning to FIG. 17C, it shows a carrying case 1740. In at least one example, the carrying case may be a charging carrying case, such that while the torch is stored in the case, the torch is recharged for subsequent use. The carrying case 1740 may carry, enclose, and charge the torch configuration 1700 when the torch configuration 1700 is collapsed.

Furthermore, while the network 101 is composed of fire devices in FIG. 1, other examples may include various other types of display devices in addition to or in place of the fire devices such that the network 101 is incorporated into a multi-media entertainment system. Other visual display devices of the network 101 shown in FIG. 1 include lighting devices 114, which may illuminate a region within a threshold radius of each of the lighting devices 114. The lighting devices 114 may be strategically positioned to provide maximum illumination of the system environment 100 or targeted lighting of specific areas of the system environment 100.

The lighting devices 114 may come in various configurations. For example, the lighting devices may be in the form of one or more of lanterns, string lights, stand-alone lights, and lights staked into the ground. Additionally or alternatively, the lights may be one or more of integrated lights of one or more of a boat, RV, and trailer. It is noted that lanterns refer to lights that are able to be carried around by a user and which may be placed on a tabletop, for example. Such lights may be wireless.

The network 101 may additionally or alternatively include other types of visual display devices, such as water features, etc., which may be operated and controlled in a similar manner in the network 101 as described herein. The types of visual display devices may be incorporated in the network 101 in various combinations and quantities according to a user's preference.

In addition to the torches 102, the system environment 100 includes other fire devices such as a first fire pit 104a, a second fire pit 104b, and a third fire pit 104c (also referred to as fire pits 104). As with the torches 102, there may be additional fire pits or fewer fire pits included in the system, in at least one example. The torches 102 and the fire pits 104 together may form a fire display controlled by a hub 110 (e.g., a central control hub 110). One or more of the fire pits 104 may comprise a speaker for providing an audio output.

The hub 110 is a controller having a processor with instructions stored in non-transitory memory that, when executed, sends control signals to control one or more of the torches 102 and the fire pits 104. For example, the control signals sent from the hub 110 may be received at controllers of the respective torches 102 and fire pits 104. Responsive to receiving the control signals from the hub 110, the controllers of the torches 102 and fire pits 104 may then actuate at least one of an electric valve and an ignitor of the respective torch and fire pit, where the electric valve controls an amount of fuel flow to a burner of the fire device where the ignitor is positioned. Via such actuation, a flame size and height may be controlled for the torches 102 and fire pits 104.

The control signals are sent from the hub 110 to one or more of the torches 102 in response to the processor of the hub 110 receiving input signals. The control signals may further be sent from the hub 110 to one or more of the fire pits 104 responsive to such input signals. In at least one example, the processor of the hub 110 receives input signals via one or more of a wireless receiver of the hub 110, a hardwired connection of the hub 110, and a user interface integrated into the hub 110 itself, where the user interface comprises one or more user input devices (e.g., buttons, dials, a touch screen) to receive the input signal. In examples where the hub 110 receives input signals via a wireless receiver, it is noted that the input signals may be received from a mobile device or other personal computing device communicatively coupled to the hub 110 via the wireless receiver. Further, in some examples and as shown in FIG. 4, the personal computing device may include a user interface with remote capabilities that can be used by the user to enter control commands at a distance from the entertainment system 120.

The input signals received at the hub 110 may include a mode selection received at the hub 110. For example, the mode selection may include selection, e.g., user selection, of a traditional mode or an audio mode. In the traditional mode, the torches 102 and fire pits 104 are operated with their respective electric valves maintained at a predetermined base position. At the base position, the electric valves of the torches 102 and the fire pits 104 are at least partially open and allow a predetermined amount of fuel to flow to their respective burners. If the electric valve of any of the torches 102 and fire pits 104 being controlled in the traditional mode is not at the base position when the traditional mode is selected, then the electric valve is first adjusted to the predetermined base position and maintained in the base position for a duration of the traditional mode. Due to the maintained position of the electric valve, a steady flame size and height is maintained in the traditional mode.

In the audio mode, the torches 102 and fire pits 104 are operated with their respective electric valves being varied in coordination to an audio input, such as music. The audio input may be selected by the user and indicated to the hub 110, e.g., via manual input, or may be provided as a pre-set audio program. As such, the network may also include at least one audio display device, such as a speaker 112, as depicted in FIG. 1.

The speaker 112 may similarly be controlled by the hub 110, which may transmit signals to the speaker based on the audio input to modulate audio parameters of the speaker 112. In some examples, audio and visual capabilities may be integrated into a single device. For example, a fire pit may be configured with a speaker, or the fire pit may include both the speaker and lighting elements, allowing one or more of a fire, music, and light display to be presented at a common device. In some examples, as shown in FIGS. 2-3, a speaker may be integrated into the hub 110, thereby allowing the hub 110 to convert the audio input into sound. The speaker 112, when communicatively coupled to the hub 110, may therefore provide accompaniment and/or amplification of the sound delivered by the hub 110 or may broadcast the audio input instead of the hub 110. Thus, responsive to receiving a user input selecting the audio torch mode and further receiving the audio input, the hub 110 may send control signals to the torches 102 and fire pits 104 based on the audio input.

In particular, the hub 110 may send control signals to adjust respective electric valves of the torches 102 and the fire pits 104 in coordination with the audio input. It is noted that the audio input may be received at the hub 110 via a wireless or a wired connection. For example, the audio input may be received at the hub 110 via wirelessly streaming the audio input to the hub 110 via a mobile device or other personal computing device. In such examples, a wireless receiver of the hub 110 may receive the audio input. As another example, the audio input may be received at the hub 110 via an auxiliary (herein, aux) input or other wired audio input. In such examples, a mobile device or other personal computing device may provide the audio input to the hub 110 via such an aux input or other wired audio input.

The electric valve may be adjusted to positions more open than the base position of the traditional mode while in the audio mode, based on the audio input. Fuel flow may thereby be greater through the fire devices when operating in the audio mode versus in the traditional mode. Additionally, the electric valve may be adjusted to positions that are less open than the base position of the traditional mode while in the audio mode, based on the audio input. In this way, flame bursts and decreases in flame size may be created for the flame display. Thus, in contrast to the traditional mode, the torches 102 and fire pits 104 produce flame sizes and heights that are varied throughout the audio mode in coordination with the audio input.

In at least one example, a flame boost mode is further available, in which a maximum fuel flow is provided to a burner. In some examples, the flame boost mode may be used for purposes of heating an accessory, such as a griddle or grill attachment. The flame boost mode may also be used for purposes of producing a maximum flame height and size, which may be of interest for lighting or theatrical effect, for example. In the flame boost mode, the electric valve of the torches 102 or fire pits 104 is actuated to a wide open position, e.g., a more open position than the base position. In at least one example, the flame boost mode may further require a mechanical valve to be manually adjusted to a wide open position, in addition to the electric valve being adjusted to the wide open position.

In examples where the flame boost mode is available, it is noted that the wide open position of the electric valve is more open than the base position for the traditional mode. That is, in examples where the flame devices include the flame boost mode, the flame boost mode creates a maximum flame height and size, which is larger than the flame height and size when operating in the traditional mode.

In at least one example, hub 110 allows for there to be separate control of the torches 102 and the fire pits 104. In separate control examples, it is noted that the mode selections for each of the fire pits 104 and the torches 102 may be made individually set. Thus, each of the torches 102 and each of the fire pits 104 is able to have its own mode selected and individually controlled via the hub 110.

Additionally, or alternatively, the hub 110 may control the torches 102 and the fire pits 104 collectively. In collective control examples, the hub 110 may control the torches 102 and the fire pits 104 all together to be in the same mode. For example, in collective control examples, user selection of the traditional mode may result in all of the torches 102 and the fire pits 104 being set to the traditional mode. Further, in the collective control examples, selection of the audio mode may result in all of the torches 102 and the fire pits 104 being set to the audio mode. As to selection of the flame boost mode, in the collective control examples, selection of the flame boost mode may result in all of the torches 102 and the fire pits 104 being controlled to have their respective electric valves in a wide open position.

Further, the hub 110 may additionally or alternatively control the torches 102 and fire pits 104 in sub-groups. In such sub-group control, sub-groups of the torches 102 and/or the fire pits 104 may be formed for control of the sub-group to be the same. For example, in sub-group control, the hub 110 may control the torches 102 together as an all torches sub-group and may control the fire pits 104 together as an all fire pits sub-group. Thus, in this example, the mode for the all torches sub-group being selected as the traditional mode would result in the torches 102 all being set to the traditional mode. Alternatively, the mode for the all torches sub-group being selected as the audio mode would result in the torches 102 all being set to the audio mode. Similarly, in this example, the mode for the all fire pits sub-group being selected as the traditional mode would result in the fire pits 104 all being set to the traditional mode. Or, alternatively, the mode for the all fire pits sub-group being selected as the audio mode would result in the fire pits 104 all being set to the audio mode.

In another sub-group control example, the hub 110 may control a portion of the torches 102 as a first torch sub-group, another portion of the torches 102 as second torch sub-group, a portion of the fire pits 104 as a first fire pit sub-group, and another portion of the fire pits 104 as a second fire pit sub-group. Moreover, a sub-group may contain both torches 102 and fire pits 104, in at least one example.

It is noted that if selection of any of the traditional mode, audio mode, and flame boost mode is also determined to initiate ignition at one or more of the torches 102 and fire pits 104, then the hub 110 may further send a control signal to activate respective ignitors of such torches and fire pits.

The hub 110 may also control the lighting device 114 via similar communication links described herein. For example, the hub 110 may command activation/deactivation of the lighting devices 114 based user input at the hub 110. As another example, an illumination intensity may be adjusted based on instructions transmitted from the hub 110. The lighting devices 114 may also be operated in different modes and sub-groups which may be assigned by the user or pre-set. For example, the lighting devices 114 may be set to a manual mode where the lighting device 114 are turned on/off and/or a brightness varied based on user input. Alternatively, the lighting devices 114, when configured with motion sensors, may be operated in an automatic mode where activation/deactivation and brightness adjustments may be executed based on detection of movement (or lack thereof), as described further below.

Turning now to FIGS. 2 and 3, a first exemplary embodiment of a control hub 202 is shown. A first perspective view 200 of the control hub 202 is illustrated in FIG. 2 and a second perspective view 250 of the control hub 202 is depicted in FIG. 3. A set of reference axes 201 are provided, indicating a y-axis, an x-axis, and a z-axis. In one example, the y-axis may be a vertical axis, oriented parallel with a direction of gravity. The control hub 202 shown in FIGS. 2-3 may be configured with any one or more control hub features described herein, such as in relation to control hub 202. In at least one example, the control hub 202 may correspond to the hub 110 shown in FIG. 1.

As shown in FIGS. 2-3, the control hub 202 has a housing 203 with a substantially rounded cuboid shape, though other shapes are possible without departing from the scope of the disclosure. Further, though various dimensions are possible, in at least one example the control hub 202 may have a rounded cube shape with approximately 13″×13″×13″ dimensions. The housing 203 may be a waterproof housing. In at least one example, the housing 203 of the control hub 202 may include a silicone skin over a plastic shell. Moreover, in one or more examples the housing 203 of the control hub 202 may be at least semi-transparent and include lighting positioned therein to provide a glowing effect for the control hub 202.

The first perspective view 200 of the control hub 202 shows a first side 204 and a second side 206 of the control hub 202, where the second side 206 is adjacent to the first side 204 of the control hub 202. The first side 204 of the control hub 202 includes a speaker 208 and a user input device 210. The user input device 210 may be a volume control including multiple buttons 210a, 210b. For example, button 210a may be a volume increase button and button 210b may be a volume decrease button. The volume increase button 210a may be in the shape of a plus sign, while the volume decrease button 210b may be in the shape of a minus sign, for example, although other shapes and configurations are possible. Thus, via the user input device 210, a volume output via the speaker 208 and any other speakers included in the control hub 202, or communicatively coupled to the control hub 202, may be adjusted. However, it is noted that the control hub 202 may instead include another input receiving means, such as a touch screen or a dial, for example.

The control hub 202 further comprises guards 212, where the guards 212 may help to protect the control hub 202 from degradation. For example, the guards 212 may be formed of a durable, flexible material, such as rubber, to absorb impact or from a more rigid material, such as plastic, to shield corners of the control hub 202. The control hub 202 may further include one or more recessed features 214, which may assist with gripping of the control hub 202 by providing additional edges for increasing traction between a user's hands and the control hub 202.

The second side 206 of the control hub 202 includes a mode user input device 218, which may be used to select a status and operating mode of the control hub 202, according to one or more examples. For example, the mode user input device 218 may be used to turn the control hub 202 on or off, as well as select an operational mode, such as the audio mode or the traditional mode. A top side 220 of the control hub 202 may be substantially flat. Furthermore, though not visible in FIG. 2, a bottom side 222 of the control hub 202 may include one or more feet. The feet may be formed of rubber in at least one example.

Turning to FIG. 3, the second perspective view 250 of the control hub 202 is shown, depicting a third side 224 and a fourth side 226 of the control hub 202. In at least one example, the third side 224 may be positioned opposite the first side 204 of the control hub 202. The fourth side 226 may therefore be positioned between the third side 224 and the first side 204 and opposite the second side 206 of the control hub 202.

As seen in the second perspective view 250, the third side 224 includes a speaker 230 and connectivity mechanisms 228, where the connectivity mechanisms 228 are formed into the third side 224 for coupling display devices to the control hub 202. For example, the connectivity mechanisms 228 may include a toggle switch 228a for electrically connecting and disconnecting the control hub 202 to an electric circuit, communication ports 228b for receiving cables, such as cables communicatively coupling components of an entertainment system (e.g., the entertainment system 120 of FIG. 1), and an audio input port 228c.

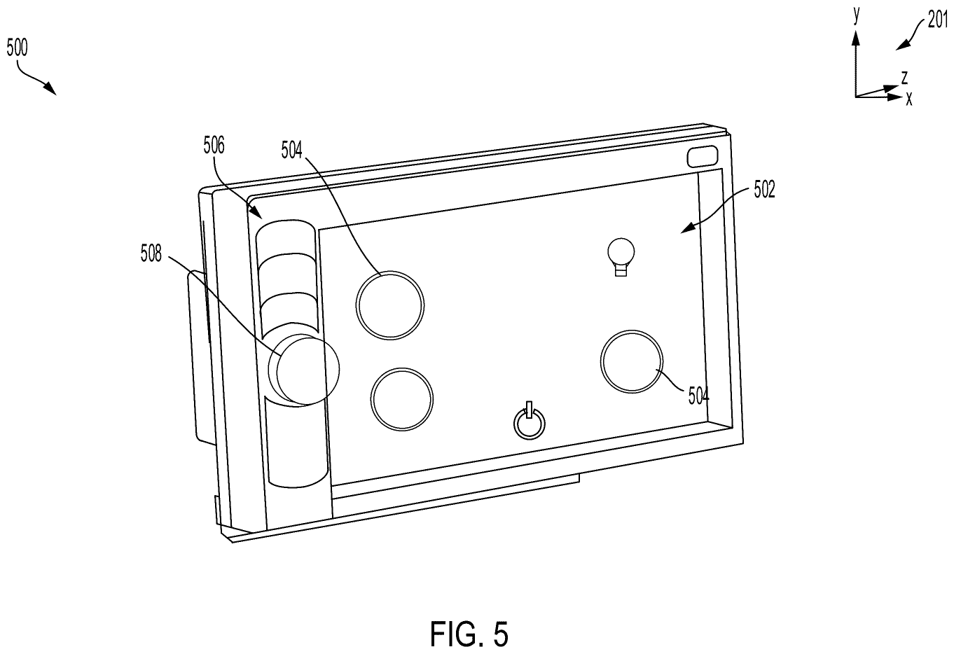

The communication ports 228b may include waterproof connections for receiving the cables. Thus, the communication ports 228b may communicatively couple the control hub 202 to the display devices, so that the control hub 202 is able to provide control signals to the display devices. In other examples (not shown in FIG. 3), the connectivity mechanisms 228 may further include additional types of ports, such as a USB port for charging/connecting a mobile device or other personal computing device, and a charging port for delivering power to the control hub 202 from a power source, such as a power outlet. The additional ports may be located at any of the sides of the control hub 202. A battery (e.g., as shown in FIG. 5) of the control hub 202 may be charged via the charging port when a suitable electrical system, e.g., a cable and converter, are coupled to the charging port. Additionally, the control hub 202 may be directly powered by the power source through the charging port during operation of the control hub 202.

The connectivity mechanisms 228 further includes an audio input port 228c for receiving an audio input. The audio input port 228c may be an aux input, for example, though other possible audio input ports are possible without departing from the scope of this disclosure, in place of or in addition to the audio input port 228c. For example, as detailed at FIG. 5, the audio input may be received wirelessly via a wireless receiver housed inside of the control hub 202 in addition to a hard-wired route via an aux cable coupled to the audio input port 228c.

A second exemplary embodiment of a control hub 400 is shown in FIG. 4. In one example, the control hub 400 may correspond to the hub 110 of FIG. 1, used to control operation and modulation of a network of an entertainment system, such as the network 101 of FIG. 1, the network including the control hub 400 and display devices. As described above, with reference to FIG. 1, the network may be included in the entertainment system to provide both audio and visual entertainment to an audience. The control hub 400 may include a first unit and a second unit, where the first unit may be a user interface 402 and the second unit may be a base 404 of the control hub 400.

By dividing the control hub 400 into two units, an overall size of the control hub 400 may be reduced, relative to the control hub 202 of FIGS. 2 and 3. Furthermore, the separation of the control hub 400 into two units, each unit having a different role in relaying signals across the network, allow greater flexibility in a positioning of the control hub 400 within an environmental setting of the entertainment system, as described further below. The user interface 402 may be, for example, a portable computing device configured to receive user input, convert the user input into a transmissible signal that is relayed to the display devices, and receive signals from the display devices to monitor statuses of the display devices. As another example, the user interface 402 may be configured as a remote control device with buttons and dials. The signals may be relayed through the base 404 which may include various components such as electronic devices, processors, transmitters, and receivers for operating the control hub 400. In other words, the base 404 may include hardware and software enabling the base 404 to operate as a controller.

For example, the base 404 may include a box, e.g., a box formed of a rigid, durable material, enclosing the components described above, which may include hardware, such as transmitters and processing units for transmitting signals between the display devices and the user interface 402. The base 404 may include various ports 406 to which cables may be connected to communicatively couple the display devices to the base 404. The base 404 may also include a power port 408 for receiving a power cable. The power cable may deliver power to the base 404 from a power source, such as a power outlet, to enable operation of the base 404. In some examples, the base 404 may also include an internal power source, such as a power storage device (e.g., a battery), which may be charged through the power port 408. When sufficiently charged, the base 404 may be powered by the battery, rather than by the power cable and power outlet.

The base 404 may also include a toggle switch 409 for connecting/disconnecting an electric circuit of the base 404 to and from the power source. Various additional ports and connections may be included at the base, for coupling the base to different types of cables and devices, for hard-wired connection of the user interface 402 to the base 404, etc. For example, the base 404 may include an aux input port for receiving an audio input, such as an aux cable communicatively coupling an audio device such as a mobile phone, a digital music player, etc., to the base 404. Furthermore, the base 404 may include different types of transmitters and receivers, according to communication modes of the display devices, as described below.

In some examples, the base 404 may be enclosed within an aesthetically appealing housing that also buffers impact from contact with external objects. For example, the base 404 may be surrounding by a housing, such as the housing 203 of FIGS. 2 and 3, where the housing may be configured with specific properties, such as waterproofness, flexibility, traction-enhancing texturing, a desired translucency/opacity, patterns and/or logos, etc. The housing may be selected and coupled to the base 404 according to a theme of an event or an overall appearance of an entertainment system (e.g., the entertainment system 120 of FIG. 1). In one example, the housing may match an aesthetic of the display devices, such as an appearance of fire pits, fire torches, etc. As another example, the base 404 may be adapted with lighting elements that may illuminate the base through the housing when the housing is translucent. As such, the base 404 may also be a visual display device of the entertainment system, in addition to providing central control capabilities.

As described above, the base 404 may be communicatively coupled to the user interface 402, where the user interface 402 may be configured to receive input from the user, convert the input into a transmissible signal, and transmit the signal to the base 404 as executable instructions. In response to the instructions, the base 404 may be configured to adjust operation of the display devices of the network by sending instructions to the display devices, based on the signal from the user interface 402, via a transmission mode corresponding to the particular display device. For example, the user input may include requesting increased flame intensity at torches communicatively coupled to the base 404 by Bluetooth technology, while requesting decreased flame intensity at fire pits, the fire pits communicatively coupled to the base 404 by hard-wired connections. Upon receiving the instructions from the user interface 402, the base 404 may convert the instructions into suitable formats, transmit a first command to the torches as a UHF radio wave and transmit a second command to the fire pits, through a communication cable, as an electromagnetic signal. The base 404 may also be configured to receive signals, via a suitable transmission mode from the display devices to provide feedback on a response of the display devices to the transmitted instructions. In some examples, the feedback may be further relayed to the user interface 402 to provide confirmation to the user of the reciprocating adjustments to the display devices.

The user interface 402 may be a portable computing device, such as a tablet, that is coupled to the base 404 via at least a wireless communication link. For example, the user interface 402 may communicate with the base 404 over a wireless network, by a Bluetooth connection, etc. The wireless network may be provided via a satellite connection, such as Starlink, in one or more examples. The user interface 402 may also be communicatively coupled to the base 404 by a hard-wired connection, e.g., a communication cable. In one example, the user interface 402 may be charged via a charging cable coupled to ports at each of the user interface 402 and the base 404.

By enabling the user interface 402 to communicate with base 404 wirelessly, the user interface may be positioned at a distance, e.g., spaced away, from the base 404 within a threshold radius of the base 404. The threshold radius may be a furthest distance of separation between the user interface 402 and the base 404 that maintains wireless connectivity therebetween, e.g., the threshold radius may be a maximum communication range of transmitters and receivers of the user interface 402 and the base 404. In this way, the user interface 402 may be positioned at a location convenient for the user to control the entertainment system. For example, when the entertainment system is located in a backyard of a house, the user interface 402 may be mounted to a wall of the house, proximate to the backyard. The user interface 402 may also be mounted directly at the base 404 or at the housing of the base 404.

The user interface 402 may include a user-interactive display screen 410, which may be a touch screen, for example. However, other configurations of the user interface 402 are possible without departing from the scope of the present disclosure. For example, the user interface 402 may instead be similar to a remote controller, having a plurality of buttons for selecting commands. In other examples, the user interface 402 may have a combination of a screen, without or without touch-input capabilities, and buttons. In yet other examples, the user interface 402 may further be configured to receive voice commands via an audio receiver implemented at the user interface and/or include motion sensors, where detection of motion (or lack of detect motion) may adjust the user interface 402 between active and sleep operating modes.

Various options for operating the entertainment system may be available via the user interface 402. As shown in FIG. 4, the display screen may include user-selectable icons, such as a first icon 412 for selecting a flame-only mode. In the flame-only mode, fire devices of the display devices, such as torches and fire pits, may provide visual display of flames without projecting sounds or exhibiting lighting effects, for example. A second icon 414 displayed at the display screen 410 of the user interface 402 may allow the user to adjust flame intensity at one or more of the fire devices. A third icon 416 may enable synchronization of the fire devices to an audio input, such as music.

For example, upon selecting the third icon 416, the user may be prompted to choose an audio option, e.g., a song, a beat, a sound, etc. Furthermore, the user may indicate an audio input mode. As an example, a first audio input mode may include receiving the audio input via the aux input at the base 404. Alternatively, the user may select a second audio input mode, which may be a manual entry mode where the user may choose an audio option from a pre-set list of audio options saved at a processor memory of the control hub 400. As another example, the control hub 400 may be communicatively connected to a large scale audio database, such as the Internet or a Cloud server, allowing the user to search, locate, and select the audio option from the audio database in the second audio input mode. As yet another example, the audio input may be received from a mobile device or other personal computing device, that is communicatively linked to the user interface 402. The audio option, regardless of audio input mode, may then be played at the audio display devices of the entertainment system.

The flames of the fire devices may be variably driven, e.g., the flame intensity varied, according to the audio option. As an example, the flames may be driven in time to a beat of a song. A volume at which the audio option is projected, e.g., through speakers of the user interface 402 and/or through an audio display device coupled to the control hub 400 as a speaker, may be adjusted by the user by engaging a fourth icon 418 at the display screen 410 of the user interface 402.

The user interface 402 may also allow the user to set channels, e.g., the sub-groups described previously, where the display devices of the network may be grouped into channels according to the user's preference. For example, icons for a first channel option 422 and a second channel option 424 are shown at the display screen 410 of the user interface 402. Each channel option may represent a group of display devices selected from the display devices communicatively coupled to the control hub 400. As an example, the first channel option 422 may include the fire devices and the second channel option 424 may include water feature devices and/or lighting devices. The water feature devices may include water fountains, irrigation systems, etc., and the lighting devices may be individual lighting fixtures or may be lighting elements incorporated into the fire devices, water feature devices, and or at the control hub 400. By selecting the channel option, the user may modify operation of the corresponding group of display devices.

The icons displayed at the display screen 410 may change according to which channel option is chosen. For example, the icons shown in FIG. 4 may correspond to the selection of the first channel option 422 (which may be highlighted, for example, upon selection). The icons, therefore, represent parameters specific to the fire devices. When the second channel option is chosen, the icons may instead represent parameters specific to the water feature devices and/or lighting devices. However, when the group of display devices include display devices of different types, parameters corresponding to all of the included types of display devices may be presented.

In one example, the user may assign the display devices to the channel options. The user may navigate to a menu screen at the user interface 402, for example, where a menu displayed at the menu screen may include an option to create and/or modify the channel options. The user may then indicate and/or adjust which available display devices (e.g., the display devices detected to be coupled to the control hub 400) are to be included in a channel option. Further, the user may indicate which control parameters are associated with each channel option.

In another example, the channel options may not be selectable by the user, and may instead be an automatic selection to provide assigned groupings of the display devices, based on which display devices are detected to be coupled to the control hub 400. In addition, in some examples, when the channel options are automatically assigned, e.g., pre-set, the control parameters associated with each channel option may also be pre-set, therefore presenting the user with a set of allowable parameters which may be adjusted by the user. For example, the pre-set channels may include channels separating the available display devices based on type, on mode of communication, etc. In other examples, the user may choose a number of channel options to which the available display devices may be assigned. Alternatively, the number of channel options may be automatically set based on which display devices are coupled to the control hub 400.

When the user selects one of the channel options, e.g., taps or swipes an icon representing the channel option, or gives a voice command, etc., the control parameters for the channel option is displayed at the display screen 410. For example, as shown in FIG. 4, the first channel option 422 is selected and the control parameters for the fire devices are displayed. Upon selecting the second channel option 424, the control parameters for the display devices grouped into the second channel option 424 may instead be displayed. As such, the user may easily toggle between the channel options to modify the corresponding control parameters.

In yet other examples, the user may choose to not group the display devices into the channel options and may instead control each display device individually. For example, each display device may have a communication channel and/or IP address and operation of each display device may be controlled and adjusted independent of the other display devices. Furthermore, in some examples, the display devices may be grouped but the user may be able to input operating instructions to the display devices according to both the groups of display devices and to the individual display devices.

In some instances, entertainment programs may be provided to the control hub 400 as pre-set instructions for operating the entertainment system. For example, the user may subscribe to a service, e.g., a subscription service, providing various entertainment programs for the entertainment system. The entertainment programs may include, as an example, choreographed modification of the control parameters of the display devices according to music. In one example, the subscription service may provide lists of songs, lists of music according to genre, lists of performers, concerts, etc., and the user may choose a list, individual items from the list, or multiple items/multiple lists, depending on a subscription mode ascribed to the user. Each item may correspond to a specific song, recording, set of sounds, etc., to which operation of the display devices may be synchronized in a pre-determined manner.

As a non-limiting example, the user may pay a monthly subscription fee to access a collection of entertainment programs at, for example, a host website. The entertainment programs available to the user through the monthly subscription fee may depend on which display devices are included in the user's entertainment system. For example, the entertainment system may include both fire devices and water feature devices. The available entertainment programs may therefore be pre-set displays of both the fire devices and the water feature devices, only the fire displays, and only the water feature devices, synchronized to an audio display (e.g., a song, a recording, a set of sounds, etc.). Upon selection of an entertainment program, the entertainment program may be executed at the entertainment system, as commanded via the control hub 400.

In one or more examples, executing an entertainment program with pre-set instructions (e.g., as part of a subscription service) may comprise a registration process in which a user registers entertainment devices that are owned by the user (e.g., torches, fire pits, string lights, lanterns, water features, speakers, etc.) before displaying the entertainment program. The registration process may be based on user input and/or automatic detection of entertainment devices coupled to a hub. Such registration of the entertainment devices is then used to provide advertisement suggesting additional devices that may be of interest to enhance the entertainment program. Furthermore, the registration of the entertainment devices may further be used to modify the entertainment program to function properly for the entertainment devices that are actually available for use. For example, if the entertainment program to be played has a particular combination manner of actuating lighting devices, fire devices, and sound devices together but (via the registration) it is determined that the user does not have the fire devices, then the instructions output to the lighting devices and the sound devices may be adjusted to still provide an aesthetically pleasing experience. Furthermore, based on the registered devices and/or the entertainment program being played, an alert with one or more suggested devices may be generated. For example, the alert with the one or more suggested devices may be displayed via the hub. The one or more suggested devices may be devices that are not registered but for which there are instructions included in the entertainment program being played. It is noted that since the alert is specific to the registered devices of the particular entertainment system and the entertainment program that is actually being played, a different entertainment system (with different registered devices) may have different devices suggested in an alert for executing the same entertainment program. Moreover, it is noted that since the instructions output are adjusted based on the devices available, the same entertainment program played on two different entertainment systems may control the devices differently. For example, if a first entertainment system had multiple lighting devices and a second entertainment system had a single lighting device, the multiple lighting devices may be controlled differently than the single lighting device in executing the same entertainment program.

In at least one example, a user input acknowledging the alert may be required to enable the entertainment program to be played. The input acknowledging the alert may be selection of an “ok” button, for example. It is noted that the alert may be in the form of an advertisement in at least one example, with the alert including one or more selectable graphics to purchase the suggested device(s). In one or more examples, and as further described herein, multiple entertainment systems may be coupled in a multi-link mode (also referred to as a party mode) to provide a coordinated entertainment experience across multiple entertainment systems. This is in contrast to a standard mode (also referred to as a single mode), in which a single entertainment system is used to provide an entertainment experience.

In the case of providing the entertainment program that is pre-set, execution of the entertainment program via an entertainment system in the single mode differs from execution of the entertainment program via multiple entertainment systems in the multi-link mode. For example, the entertainment program being executed via a first entertainment system in the single mode provides a curated show with tracks for different devices. Moreover, as described above, an alert may be generated providing suggested devices to add to the first entertainment system based on the devices registered for the first entertainment system and the entertainment program being executed. For example, if the tracks for the entertainment program being executed includes tracks for water devices but the first entertainment system does not have a registered water device, then the alert may suggest to add a water device.

Then, in a multi-link mode, the first entertainment system and a second entertainment system may provide the same entertainment program. In this multi-link mode, it is noted that the tracks provided for execution of the first entertainment system and the second entertainment may differ from one another based on the devices registered for the first entertainment system and the devices registered for the second entertainment system. For example, if the devices registered for the first entertainment system do not include a water device but the tracks for the entertainment program include a water device track, then the tracks sent to the first entertainment system in the multi-link mode for executing the entertainment program will not include the water device track. However, if the devices registered for the second entertainment system include a water device, then the tracks sent to the second entertainment system for executing the entertainment program will include the water device track. In this way, although the same entertainment program is being executed, the tracks sent to the first entertainment system and the second entertainment system to control the devices are different. Moreover, while the first entertainment system may receive an alert suggesting the addition of a water device, the second entertainment system may not receive an alert suggesting the addition of a water device. In this way, the alert and the execution of the entertainment program is highly adaptable to the entertainment system(s) executing the entertainment program.

A third example of a control hub 500 is illustrated in FIG. 5. The control hub 500 may be configured as a single unit that incorporates components of the user interface 402 and the base 404 of the control hub 400 of FIG. 4. For example, the control hub 500 may include a display screen 502 that displays icons 504 representing various display device types and their associated control parameters, such as audio only, fire display only, LED light show, streaming music, combined audio and fire display, etc. The display screen 502 may also be touch-sensitive and receive input from a user via contact with the display screen 502. Other information may be provided on the display screen, such as time, active communication mode, etc. A panel of buttons 506 may be arranged adjacent to the display screen and allow the user to select between viewing operating modes, music bands, a menu of options, and other viewable options, at the display screen 502. A control knob 508 may also be provided for adjusting displayed parameters, e.g., by scrolling through the parameters, for increasing/decreasing a magnitude of the displayed parameters, and the like. In some examples, the control knob 508 may also operate as a button for selecting an option from the display screen 502 and then controlling the option by rotation of the control knob 508 as a dial. The control hub 500 may further include various hardware for signal transmission, signal reception, and processing of information, as described above, for enabling communication with and control of display devices communicatively coupled to the control hub 500.

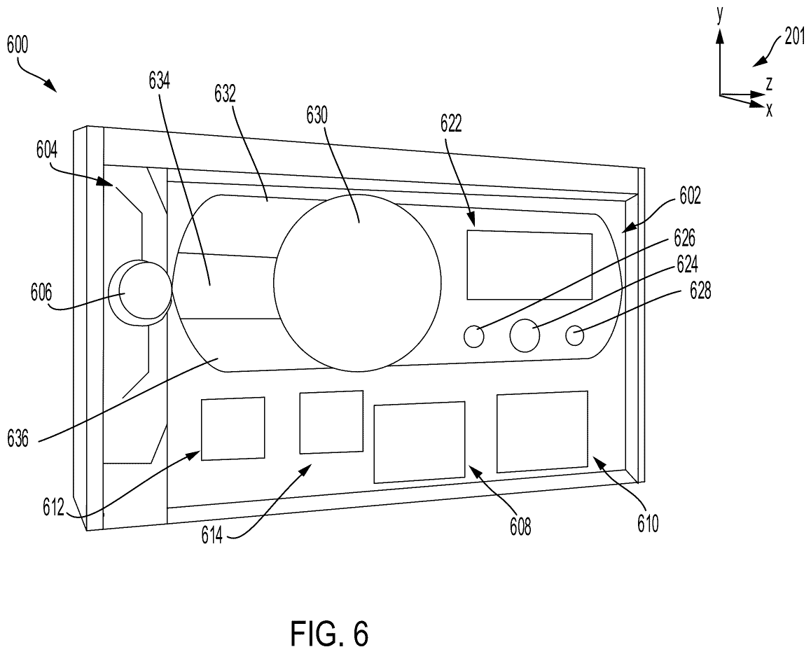

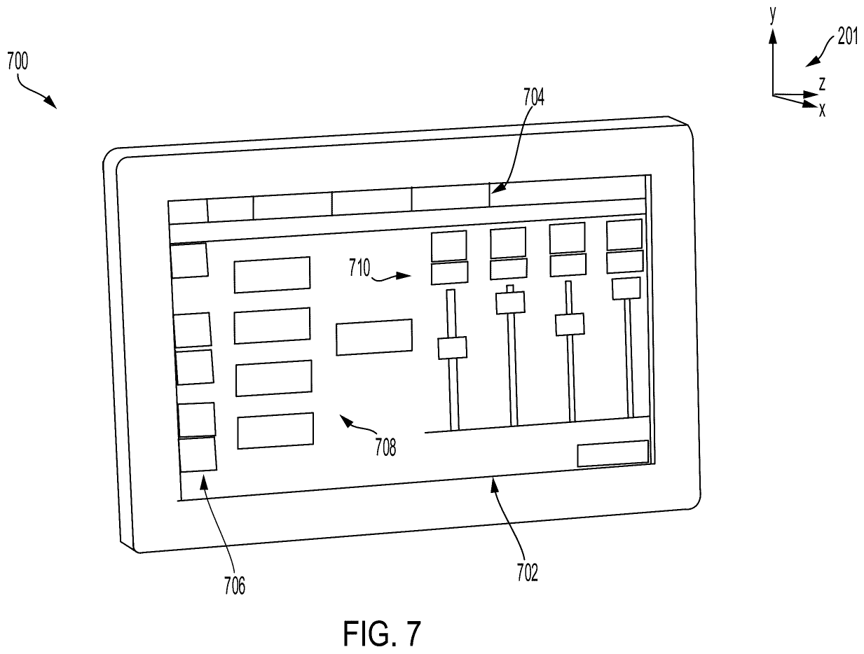

A fourth example of a control hub 600 and a fifth example of a control hub 700 are shown in FIGS. 6 and 7, respectively, the fourth example of the control hub 600 having a display screen 602 and the fifth example of the control hub 700 also having a display screen 702. Each of the control hubs 600, 700 may be similarly configured with display options, operating parameter controls, communication links, various hardware and software, etc., as described above for the control hubs of FIGS. 2-5, but illustrate variations in how information is displayed at the respective display screens. For example, turning first to FIG. 6, the control hub 600 also includes a panel of buttons 604 and a control knob 606. A first live link 608 for streaming music is indicated as selected and an upper region (with respect to the y-axis) of the display screen 602 presents a song and artist currently streaming. The display screen 602 also shows a second live link 610 for allowing a user to view new commercially available products, e.g., display devices, that are compatible with the control hub 600.

The display screen 602 may also show interface applications. The interface applications may be displayed as icons that are digital representations of buttons. For example, there may be a first icon 612 and/or a second icon 614, to select a catalogue of audio options for listening. For example, the first icon 612 may be a radio button, allowing a user to change the control hub 600 to play music from the radio and select detectable radio stations to receive and play audio from. For another example, the second icon 614 may be a stored music button, allowing a user to change the control hub 600 to select and play audio from a catalogue of stored audio data. The audio data selectable via the second icon 614 may be digital.

The display screen 602 shows an audio information display 622. The audio information display 622 may show information about the title, genre, or artist of the music or audio. Additionally, below the audio information display 622 may be a plurality of icons to control the audio, such as a play button 624 to start and pause audio. Likewise, audio information display 622 may comprise a third icon 626 and/or a fourth icon 628. The play button 624, the third icon 626, and the fourth icon 628 may be icons that are digital representations of buttons. As an example, the third icon 626 may be a rewind button and the fourth icon 628 may be a fast forward button that may be selected by a user to skip audio for a track in a forward or reverse direction, respectively. For this or another example, the third icon 626 and fourth icon 628 may be skip buttons that may be selected by a user to skip to previous or upcoming tracks, respectively, in a playlist.

The display screen 602 shows a general information display 630. The general information display 630 may show information, such as time and date. The general information display 630 may be circular in shape. Additionally, the display screen 602 may show a plurality of other applications in the form of button icons. For example, the display screen 602 may show a fifth icon 632, a sixth icon 634, and a seventh icon 636. The fifth icon 632, a sixth icon 634, and a seventh icon 636 may be digital representations of buttons. When selected by a user, the fifth icon 632 may synch the control hub 600 with a device that has wireless interconnect capabilities, such as a Bluetooth enabled device. When selected, the sixth icon 634 may alter the brightness, color, or other features of the display screen 602 to conditions of first mode to have increased visibility at night or to conditions of a second mode to have increased visibility during the day. The seventh icon 636 when selected may display an intractable list or another other graphical user interface (GUI) of the settings on the display screen 602. The list or GUI of the settings may be selectable by the user to alter settings, such as volume, brightness, color, or duration of time to enter into a stand-by/sleep mode, for the control hub 600 and display screen 602.

The control hub 700 of FIG. 7 does not include a panel of buttons (e.g., mechanical buttons such as the panel of buttons 506 of FIG. 5 and 604 of FIG. 6) or a control knob. Instead, all control capabilities are provided on the display screen 702, showing grouped icons, a portion of which may be arranged hierarchically across the display screen 702. For example, a first group of icons 704 may allow a user to choose a location amongst a set of locations where communicatively coupled display devices are located. The locations shown in FIG. 7 include a lookout area, a reception area, a meeting room, and a studio, of which the studio is shown as selected. A second group of icons 706 depict control parameters associated with the display devices located in the studio and a second third group of icons 708 show options according to a selected icon from the first group of icons 704. A fourth group of icons 710 show channel options and a user-adjustable sliding control for each channel option. For example, each sliding control may adjust a percentage of intensity for the respective devices on the channel, where 100% is a maximum intensity and 0% is a minimum intensity. In examples where a channel comprises fire devices, for example, the percentage may be indicative of a base strength of the flames. In examples where a channel comprises lighting devices, for example, the percentage may be indicative of a base brightness for the lighting devices. Other devices may be adjusted in intensity via such channel percentages.

In this way, the display devices of the entertainment system may be controlled and operated by the control hub. In one example, integrated control of all networked display devices is provided at a single, user-interactive display screen. The user may directly adjust the control parameters for specific display devices and/or groups of display devices, including selecting an audio input to which operation of the display devices may be synchronized. The control hub therefore enables a high degree of flexibility in operating the entertainment system, enabling direct user input to determine an operating mode of the entertainment system, which effects are displayed by the entertainment system, and how the effects are displayed. By allowing the user to also choose subscriber-based entertainment programs, an operating option with an intentionally lower degree of operating flexibility and a lower demand for user input may be provided. The entertainment programs may deliver pre-set instructions for operating the entertainment system which may not be altered or modified by the user. The entertainment programs may therefore alleviate a burden on the user to decide how the display devices are operated.

For example, the entertainment programs may include preset backyard settings, which may provide, as one example, a Party Program Mode, a Relax Mode, and a Custom Mode. The Party Program Mode, when selected, may set fire display devices to a Bluetooth technology mode (BTM mode) for receiving instructions from the control hub, as well as lighting devices. Alternatively, the fire display device may be set to another electronic interconnect technology mode (ETM) for devices with electronic interconnects that may operate similarly to Bluetooth. Parameters of the fire display devices (e.g., flame height/intensity) and of the lighting devices (pulsing and/or changes to brightness) may include flames and illumination provided by the devices in time to music that is streamed in response to operation in the Party Program Mode. The music may be streamed according to a pre-set Party radio station, which may play upbeat music.

The Relax Mode may include operating of the fire devices with only flames (no pulsing) at a highest intensity. The lighting devices may be adjusted to 50% brightness and a Relax radio station may be streamed, which may play relaxing music. Alternatively, the Custom Mode may allow the user to define customized pre-set settings for the entertainment programs.

A plurality of radio stations may be provided by subscription to a streaming channel. The streaming channel may include the Party radio station, the Relax radio station, a Festival Live radio station, which may stream live music from music festivals, and a Finds radio station, which may stream new music located based on search algorithms implements at the control hub.

Additionally, a monthly subscription may be provided to deliver curated shows on a weekly basis. For example, a weekly download may be sent to each subscribing member that may provide updates to services and products, troubleshooting information, information regarding how to use services, and live links to view new products (as shown in FIG. 6), which may allow the user to purchase products directly through the control hub. In some examples, the monthly subscription may also provide a curated show to a specific song on a specific day of the week (e.g., on Fridays) as well as during holidays as bonus shows. Operation of the display devices, including the fire devices, the lighting device, and speakers, may be coordinated according to a program developed each week, which may be particularly desirable for a commercial environment, such as a bar or a hotel.

The entertainment system may be controlled by the control hub based on different input modes and techniques. For example, the user may activate the control hub by interacting with the user interface, such as by touching the display screen of the user interface, gesturing in front of the user interface, and/or by voicing a command. Commands may be input to the control hub by touch (e.g., swiping/tapping the display screen) and/or delivering vocal instructions. The input received from the user may be transmitted to the display devices according to a communication mode of the display devices, such as a hard-wired connection via a communication cable, a wireless network such as a wireless local area network (WLAN), Bluetooth connectivity, infrared communication, a direct radiofrequency channel between the display devices and the control hub, etc. It is noted that the wireless network access may be satellite enabled, such as provided by Starlink, for example.

Furthermore, additional input devices may be linked to the control hub, e.g., either to the user interface or directly to receivers of the control hub, such as mobile devices with permitted communication with and access to the control hub. In some examples, features shown at the display screens of the control hubs of FIGS. 4-7 may be adapted for mobile devices. The user may thereby control the entertainment from a remote location over a mobile communication system. The entertainment system may incorporate different types of communication modes and the associated hardware and software for enabling the communication modes may be integrated into a single control hub. In some examples, the control hub may be customized according to an anticipated configuration of the entertainment system. For example, the user may request that the control hub include only transmitters and receivers for Bluetooth connectivity if the only Bluetooth communication is to be utilized amongst the display devices and the control hub.

Additional benefits of the entertainment system include optional automated operation of the lighting devices. For example, the lighting devices may be grouped according to zones and a brightness of each group may be set independently. The control hub may provide different operation modes, including a Green mode where all of the lighting devices may be maintained at 70% brightness. As the lighting devices may each be configured with a motion sensor that enables detection of motion within a threshold proximity to the lighting device, when motion is detected at one or more of the lighting devices, the lighting devices may be commanded to increase their brightness. In another example, the lighting devices may be operated in a People detecting mode where the lighting devices are maintained at 70% brightness when no motion is detected. As a person approaches one of the lighting devices, the lighting device may be activated and turned on and its brightness slowly increased as the person moves closer to the lighting device. As the person moves away and leaves the threshold proximity of the lighting device, the brightness of the lighting device may be decreased to 70%.

Turning now to FIG. 8, it shows an example block diagram of a network 800 of an entertainment system, such as the entertainment system 120 of FIG. 1. As seen in FIG. 8, a control hub 802 is configured to receive an audio input 804 via an audio input source 806 and a user input 808 via a user input device 810. The control hub 802 may be configured as any of the control hubs of FIGS. 2-7. However, preferred embodiments may include the control hubs shown in FIGS. 4-7 having a user-interactive display screen, such as a touch screen. In particular, the control hub 802 may be implemented as a mobile device, as one example. That is, the mobile device itself may be the control hub 802. In examples where the mobile device itself is the control hub 802, it is noted that the user-interactive display screen may be accessed via an application on the mobile device. The control hub 802 may further include at least one wireless receiver 812 for receiving one or more of the audio input 804 and the user input 808 in wireless form, as described above. Additionally or alternatively, the control hub 802 may be configured to receive one or more of the audio input 804 and the user input 808 via at least one wired connection.

The audio input source 806 may be a user device, such as a mobile device or other personal computing device, in one example. In other examples, however, the audio input source 806 may be a streaming music service, as described above. Thus, in examples where the control hub 802 receives the audio input 804 wirelessly, the audio input 804 may be streamed from the audio input source 806 to the wireless receiver 812 of the control hub 802. In examples where the audio input 804 is received from the user device via a wired connection, it is noted that a wired connection may be provided between the user device and the control hub 802. For example, the wired connection may be provided via an aux input, though it is noted that other wired connection options are also possible.

The user input 808 may be received via one or more user input devices 810 of the control hub 802. For example, the user input device(s) 810 may be mobile devices that are communicatively coupled to the control hub 802. In some instances, as described above, the user input device 810 may be integrated into a single unit as the control hub 802, e.g., as a touch screen. The user input 808 may be a signal provided to the control hub 802 indicating one or more of a requested volume adjustment and a requested mode for the control hub 802, for example. The requested mode may include any of the modes discussed herein, such as the audio mode, the traditional mode, the flame boost mode, and the off mode, for example.

The control hub 802 includes instructions stored in non-transitory memory that are executable to actuate various components responsive to receiving one or more of the audio input 804 and the user input 808. Thus, responsive to receiving one or more of the audio input 804 and the user input 808 at the control hub 802, the control hub 802 may output control signals to actuate one or more components, such as components included in one or more visual display devices, e.g., fire devices 814 and one or more audio display devices, e.g., speakers 816. The fire devices 814 may include any of the torches and fire pits disclosed herein, for example. The speakers 816 may include the speakers formed into the control hub 802, in at least one example, as well as speakers coupled to the control hub 802, such as the speaker 112 of FIG. 1.

As an example, the user input 808 may include a request to increase or decrease a volume. In response to the request, the control hub 802 may output an audio control signal 818 to adjust a volume output of one or more of the speakers 816. As another example, the user input device(s) 810 may include a request a request to operate the entertainment system in the traditional mode. In response to the request, the control hub 802 may output a visual control signal 820 to the fire devices 814 to electrically actuate an electric valve in each of the one or more fire devices accordingly, the valve controlling fuel flow to a burner of the respective fire device. The visual control signal 820 may include a command to actuate the electric valve to a base set position for the traditional mode, as previously discussed above.

If the traditional mode is requested via the user input 808, it is noted that the visual control signal 820 output to the fire devices 814 is not based on the audio input 804, even if the audio input 804 is being received at the control hub 802. Rather, in the traditional mode, the control hub 802 outputs the visual control signal 820 to the fire devices 814 to actuate the electric valve to the base position for the traditional mode regardless of the audio input that may be received. However, in at least one example, it is noted that the control hub 802 may output the audio control signal 818 to the speakers 816 based on receiving the audio input 804, even when in the traditional mode. That is, the audio input 804 may be provided via the speakers 816 of the hub in the traditional mode, though the audio input 804 is not being used to adjust a position of the electric valve.

As another example, the user input 808 may include a request to operate in the audio mode and the control hub 802, upon receiving an audio input 804, may output the visual control signal 820 to the fire devices 814 to electrically actuate the electric valve in each of the fire devices 814, where the visual control signal 820 is based on the audio input 804 received. For example, the audio input 804 may be a music input, and the control hub 802 may output the visual control signal 820 based on the audio input 804 to adjust the electric valve position and coordinate the flame height and size of the fire devices to the audio input 804. In this way, the position of the electric valve may be varied in the audio mode in a manner coordinated with the audio input 804.

In cases where the audio mode request is received at the control hub 802 via the user input 808 but the audio input 804 is not being received at the control hub 802, the control hub 802 may output the visual control signal 820 to the fire devices 814 to actuate the electric valve in each of the fire devices to an audio mode base position. The audio mode base position may be a same or different position than the traditional mode position. In at least one example, the audio mode base position may be an at least partially open position that is less than the wide open position for the valve.

In one or more examples, the control hub 802 may be coupled to the fire devices via a common line (e.g., a communication cable), where the common line is coupled to the control hub 802 via one or more ports. In such examples where the control hub 802 is coupled to the fire devices via the common line, it is noted that the visual control signal 820 output from the control hub 802 to the common line is provided to all of the fire devices coupled to the common line.

The control hub 802 may be coupled to additional display devices, including lighting devices 824, such as the lighting devices 114 of FIG. 1, and water features 826, which may be devices providing displays based on water, such as fountains. The water features 826 may include integrated lighting devices such that, when instructed by the control hub 802, may vary an intensity of water flow, spray, pressure, etc., as well as a brightness and pulsing of illumination by the integrated lighting devices, in a synchronized manner with respect to the audio input 804 and/or the user input 808. Similarly, the lighting devices may be commanded to vary their brightness and/or be pulsed in time to the audio input and/or according to the user input 808. The control hub 802 may therefore send a lighting device signal 828 and a water features signal 830 to the lighting devices 824 and the water features 826, respectively, to produce desired outputs at the display devices.

In at least one example, the hub may further comprise a battery 822. The battery 822 may serve as a source of power to one or more of the control hub 802, the user input device(s) 810, the speakers 816, the lighting device 824, and the water features 826 of the network 800. The battery 822 may further provide power to charge a user mobile device via a USB port. In at least one example, the battery 822 may be a 9800 mAh battery that is chargeable via a charging port, as previously described.

A method 900 for operating an entertainment system, the entertainment system including a network, is depicted in FIG. 9. The network includes a control hub and one or more display devices communicatively coupled to the control hub, where the control hub is configured to control operation of the one or more display devices. The entertainment system may be, as one example, the entertainment system 120 of FIG. 1, and may include, in addition to fire only devices (e.g. torches), audio only devices (e.g., speakers), and combination fire and audio devices (e.g., one of the fire pits), other types of visual display devices, including lighting devices and water feature devices. Instructions for carrying out the methods 900 and 1000 may be executed by a controller, such as the hub 110 of FIG. 1, and any of the control hubs of FIGS. 2-7, based on instructions stored on a memory of the control hub and in conjunction with signals received from transmitters of the entertainment system, such as from a user interface of the control hub. The control hub may output command signals to receivers of the one or more display devices to adjust operation of the one or more display devices, according to the methods described below.

At 902, the method 900 includes confirming if the control hub is on, e.g., electrically connected to a power source and ready to relay signals. For example, the control hub may be on when a toggle switch, such as the toggle switch 228a of FIG. 3 or the toggle switch 409 of FIG. 4, is adjusted to an “on” position. If the control hub is not on, the method 900 proceeds to 904 to maintain a current operating status of the control hub. As an example, the control hub may be off, e.g., deactivated, or in a stand-by/sleep mode. The method 900 returns to the start.

If the control hub is on, the method 900 continues to 906 to detect and identify the one or more display devices communicatively coupled to the control hub. The network may include various audio and visual display devices, including but not limited to fire devices (e.g., fire pits and torches), water feature devices, lighting devices, and speakers. Detecting and identifying the one or more display devices may, in some examples, include transmitting querying signals to the one or more display devices to determine which of the one or more display devices are in an active mode and ready to be operated. For example, each of the display devices may include switches for adjusting the respective display device between on/off modes. As such, only the display devices adjusted to the on mode (e.g., active display devices) may be deemed an active member of the network of the entertainment system and operation of the one or more display devices may be constrained to the active display devices. Upon detecting and identifying device type, quantities of each type, device status, etc., method 900 includes confirming if user input is received at 908.

User input may be delivered to the control hub by one or more techniques, including touch input at a display screen of a user interface of the control hub and/or at buttons of the user interface and/or control hub, voice commands input to audio receivers of the control hub, gesturing within a detection region of motion detectors of the control hub, a communication link coupling the control hub to a mobile device, etc. The user input may therefore be detected by suitable receivers at the control hub, e.g., detectors for detecting pressure at the display screen, the audio detectors, and the motion detectors, etc. If the user input is not received, the method 900 proceeds to 910 to operate the one or more display devices according to previous operating parameter settings (e.g., as stored at the memory of the control hub). The method 900 returns to 908.

If reception of the user input is confirmed, the method 900 continues to 912 to convert the user input into signals according to the communication modes of the one or more display devices that are active. As an example, the one or more display devices may communicate with the control hub via different types of communication modes, including hard-wired communication modes (e.g., communication cables), and wireless communication modes (e.g., WLAN, Bluetooth, infrared communication, direct radiofrequency channel, etc.). The signals may be converted to a communication mode suitable for a respective display device and thereby delivered, e.g., transmitted, to the respective display devices at 914. The method 900 then returns to the start.

Turning now to FIG. 10, a second example system environment 1000 is shown. One or more of the display devices shown in the second example system environment 1000 may be the same or similar to the display devices previously discussed herein. Furthermore, it is noted that the same or similar hub and hub control discussed previously herein may further be carried out in the second example system environment.

As detailed below, though there are different types of display devices included in FIG. 10, each of the display devices comprise a network-based controller. When the network-based controllers of the display devices are connected to the same network, the same input (such as an audio input) can be used to control the different types of display devices in a manner that is synchronous.

Looking to FIG. 10, the second example system environment 1000 includes both an indoor environment 1002 within an RV 1004, as well as an outdoor environment 1003 of the campsite because display devices connected to the network 101 of the entertainment system 120 are located both in the RV and outside in the campsite.

The display devices connected to the network 101 in FIG. 10 provide various types of entertainment displays, where the types of displays include fire, water, lighting, and audio based entertainment displays. It is noted that the lighting type displays refer to electric lighting displays. Each individual display device may be configured to provide an entertainment display comprising one or more of the different types of displays.

The display devices connected to the network 101 of FIG. 10 include fire torches 102a, 102b, 102c, 102d (also referred to as fire torches 102), fire pit 1006 (which may be the same or similar to fire pit 104c), speakers 112, lighting devices 114, and one or more water devices 1008.

The fire torches 102 in FIG. 10 provide a fire display and may not comprise speakers to provide an audio output. Thus, the fire torches 102 in FIG. 10 may be referred to as fire only devices. The fire pit 1006 may provide a fire display and an audio output, where the audio output is provided via a speaker integrated into the fire pit 1006. Thus, the fire pit 1006 may be referred to as a combination fire and audio device. The speakers 112 may provide an audio output without providing other types of entertainment displays. Thus, the speakers 112 may be referred to as audio only devices. The lighting devices 114 may provide an electric light output without providing other types of entertainment displays. Thus, the lighting devices 114 may be referred to as lighting only devices. Alternatively, it is noted that one or more of the lighting devices 114 may further have a speaker integrated therein to also provide an audio output. In such examples, these particular lighting devices may be referred to as combination lighting and audio devices. Lastly, water features, such as a water feature 1008a and a water feature 1008b, of the water devices 1008 may provide a water display without providing other types of an entertainment display. Thus, the water devices 1008 may be referred to as water only devices. Alternatively, one or more of the water devices 1008 may further have a speaker integrated therein to also provide an audio output. In such examples, these particular water devices may be referred to as combination water and audio devices. In some examples, the water devices may be sprinklers or other irrigation devices. Other combinations of the types of entertainment displays are possible without departing from the scope of the disclosure. It is noted that devices which output multiple types of displays for entertainment may be collectively referred to as combination display type devices, whereas devices which only output one type of display for entertainment may be collectively referred to herein as single display type devices.

In order to connect to the network 101, each of the display devices comprises a network-based controller 1010. The network-based controller 1010 may connect the respective display device for which it is provided to the network 101 via a wireless connection. The wireless connection may be a short-range wireless connection such as a Bluetooth connection, for example. Other wireless connection types such as WLAN are also possible, however. Via connection of the network-based controllers 1010 of the various types of display devices to the network 101, the different types of display devices are able to be controlled in a synchronized manner via hub 110.

In one or more examples, each of the display devices may further comprise a connect mode input 1012, where the connect mode input 1012 may be a button, dial, or other user input on the display device. Responsive to activation of the connect mode input 1012 for a display device (e.g., by pushing the connect mode button), the network-based controller 1010 of the same respective display device automatically searches for a wireless network to join. Once a network is found, the respective display device may then proceed to join the network (e.g., join via a Bluetooth connection). Thus, in the example at FIG. 10, the display devices join the network 101 by, after activation of the connect mode input 1012, searching for a network via network-based controller 1010, and once network 101 is found, the network-based controller 1010 proceeds to join the network 101 via a wireless connection such as a Bluetooth connection or a satellite wireless network connection (e.g., Starlink).

In some examples, the display device may join the network automatically without the need for authentication (e.g., if the display device has previously joined the network). In other examples, authentication of the display device may be required before allowing the display device to join the network. For example, user authentication of the display device may be required at the hub 110 prior to allowing the display device to join the network.

Though the display devices of FIG. 10 provide different types of displays for entertainment, because the display devices are connected to the same network 101 via their respective network-based controllers 1010, they are able to be controlled in a synchronous manner.

As just one example, the hub 110, which is shown as a mobile device in FIG. 10, is connected to network 101 in FIG. 10. Further, all of the display devices discussed above concerning FIG. 10 are also connected to the network 101. An audio input may be provided from the hub 110 to the display devices on the network 101 as part of a request for a multi-media entertainment display that may be a component or feature of the entertainment system 120. The respective network-based controllers 1010 of the display devices on the network 101 receive the audio input from the hub 110. Then, responsive to receiving the audio input from the hub 110, the network-based controllers 1010 provide a display via their respective display devices by actuating components of their respective display device. For example, the network-based controllers 1010 for the fire torches 102 may actuate one or more valves and/or an ignitor based on the audio input to adjust the fire display of the fire torches 102. As another example, the network-based controllers 1010 for the water devices 1008 may actuate a pump to adjust the water display for the water devices 1008. As a further example, the network-based controller 1010 for the fire pit 1006 may both actuate the speaker of the fire pit 1006, as well as one or more valves and/or an ignitor based on the audio input to adjust the combination fire and audio display of the fire pit 1006.

Thus, the same audio input from hub 110 may be used by the respective network-based controllers 1010 of the display devices on the network 101 to provide different types of displays, where these different types of displays are coordinated to the same input (e.g., audio input) and thus are also coordinated with each other.

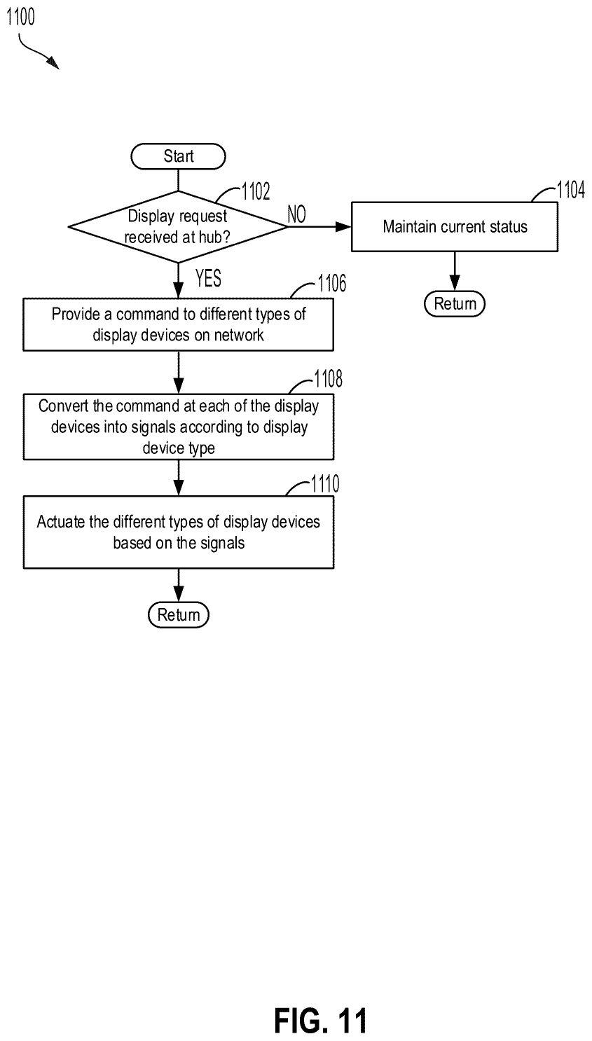

Turning now to FIG. 11, FIG. 11 shows a second example method for operating the entertaining system. The method 1100 may be carried out via one or more of the display devices discussed herein. It is noted that method 1100 is carried out for cases in which more than one type of display device is connected to the same network as a hub.

At step 1102, method 1100 comprises determining whether or not a display request has been received at hub (e.g., hub 110 of FIG. 1). The display request may be a request for display devices on a same network as the hub 110 to provide a display. For example, the display request may include a request for the display devices to provide a display coordinated to an audio input, such as music. In one or more examples, the hub 110 may be a mobile device or other personal computing device. Thus, determining whether or not a display request has been received may include determining whether or not a user input has been received via an application of the mobile device to provide a display request. If it is determined that no display request has been received, then method 1100 proceeds to step 1104 to maintain a current status for the hub and all display devices on a same network as the hub. Following step 1104, method 1100 returns.

If it is determined that a display request has been received at step 1102, then method 1100 proceeds to step 1106. It may be determined that a display request has been received responsive to detecting a user input. The user input may be received via the hub, such as through an application on a mobile device, in at least one example. The display request may be a request for display devices on the same network as the hub to provide a display coordinated to an audio input, in at least one example.

At step 1106, method 1100 includes providing a command from the hub to display devices on the same network as the hub. In particular, step 1106 includes providing a command from the hub to different types of display devices on the network. The command may include the audio input, in at least one example. It is noted that the same command may be provided to the display devices on the network.

Following step 1106, method 1100 proceeds to step 1108. As step 1108, each of the display devices that received the command from step 1106 converts the command into signals based on the display device type. In particular, the network-based controller (e.g., network-based controller 1010) for each of the devices that received the command converts the command into signals for actuating the device based on the particular display device type. For example, a first display device that receives the command may be a fire only device (e.g., torches 102) and a second display device that receives the command may be a combination fire and audio device (e.g., fire pit 1006). Thus, although the same command is received at both the first display device and the second display device in this example, the respective network-based controller in each of the first display device and the second display device will convert this same command into different signals based on the different device types. In this example, the first display device (fire only) may convert the command into signals for actuating one or more valves and/or an ignitor based on the command without any audio actuation commands. The second display device (a combination fire and audio), in contrast, may convert the command into signals for both actuating one or more valves and/or an ignitor, as well as actuating a speaker based on the command. In a case where the command is an audio command, it is noted that both the signals for the first display device and the second display device will be coordinated to the audio command.

Following step 1108, method 1100 proceeds to step 1110. At step 1110, the different types of display devices are actuated based on the signals from step 1108. In this way, using the same command (e.g., an audio command such as music), different types of display devices may be operated. As a result, different types of display devices are able to be actuated in coordination to the same command output from the hub.

In some examples, the user input may include instructions for only a portion of the active display devices of the one or more display devices. For example, the active display devices may include fire devices and lighting devices but a user may choose to only operate the fire devices and the lighting devices may remain in a stand-by mode, or the user may select only a portion of the fire devices and/or a portion of the lighting devices to be operated. Furthermore, as described above, the one or more display devices may be grouped into channels, which may be assigned by the user or automatically selected and assigned based on device type, communication mode, etc. The user may input commands to one of the channels, all of the channels, or a portion of the channels.

As another example, the control hub may receive an audio input via a hard-wired connection (e.g., a cable coupled to an aux in port of the control hub) or by a wireless connection, where the audio input may be, for example, music provided by a mobile device or an audio device, such as a device for playing audio files. The audio input may also be an audio selection indicated and chosen by the user at the user interface of the control hub. The user input may further include a request for the operation of the active display devices to be synchronized to the audio input. Operating parameters of the active display devices may therefore be adjusted according to the audio input as determined and monitored by audio receivers of the control hub, e.g., audio receivers configured to read and interpret an audio file delivered by the audio input and/or detect and monitor audio effects of the audio input (e.g., frequency, volume, rhythm, etc.) as the audio input is translated to sound broadcasted by the audio display devices. For example, flame intensity at the fire devices, water flow at the water feature devices, and light intensity/color at the lighting devices may be pulsed and varied to provide visual effects of the entertainment system that complement the audio effects.

In this way, networked display devices of an entertainment system may be coordinated in a simple manner. It is noted that reference to signals, such as input signals, output signals, and control signals, refer to electric signals, in at least one example. The signals may be transmitted and received at a control hub of the entertainment system, the control hub configured to communicate with the display devices via a variety of communication modes. The control hub may provide centralized, customizable control of the entertainment system, thereby allowing a user to adjust all display devices connected to the control hub easily, e.g., without specialized knowledge or skill, and efficiently.

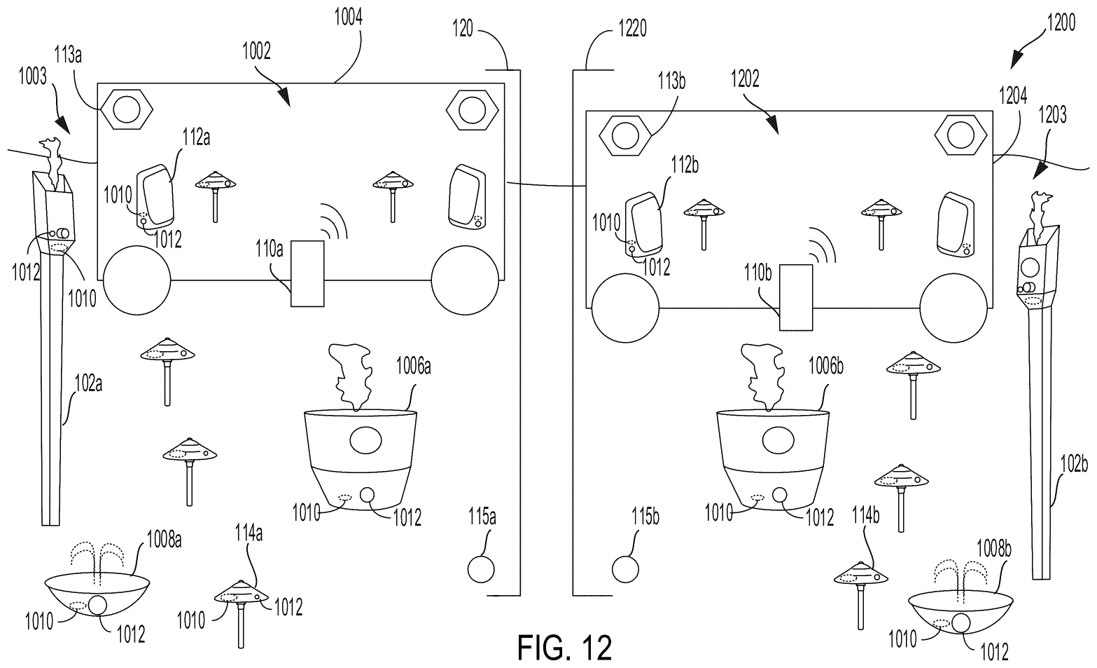

Turning now to FIG. 12, FIG. 12 shows a third example system environment 1200. It is noted that there are many similarities between devices shown in the third example system environment 1200 and the second example system environment 1000 shown in FIG. 10. The elements in FIG. 12 labeled similarly to those shown in FIG. 10 may be the same or similar to the elements in FIG. 10 and may not be re-introduced.

The third example system environment 1200 is an outdoor environment. As seen in FIG. 12, there is a first RV 1004, and a first entertainment system 120 comprises one or more devices that are communicatively coupled with a first central control hub 110a. Likewise there is a second RV 1204. The third example system environment 1200 may have a plurality of devices communicatively coupled with the first central control hub 110a or second central control hub 110b. The third example system environment 1200 may comprise a plurality of sub environments. Such environments may include the outdoor environment 1003 and the indoor environment 1002 that house devices of the first entertainment system 120. Additionally, the third example system environment 1200 may comprise an outdoor environment 1203 and an indoor environment 1202, wherein the indoor environment 1202 is within the second RV 1204. The outdoor environment 1203 and indoor environment 1202 may house devices. The devices of the first entertainment system 120 may include one or more of the devices shown in FIG. 10. For example, one or more of the torch 102a, fire pit 1006a, lights (including light 114a), water feature 1008a, and speakers (including speaker 112a) shown in FIG. 12 may form part of the first entertainment system 120. Additionally, cameras (including camera 113a) and/or GPS devices 115a, may form part of the first entertainment system 120. For this example, the torch 102a, fire pit 1006a, lights (including light 114a), water feature 1008a, and speakers (including speaker 112a) cameras (including camera 113a) and/or GPS devices 115a may be communicatively coupled. The cameras may be security cameras configured to record an object and/or body. In at least one example, each of the cameras may include one or more sensors, such as a motion sensor and/or a thermal sensor, to trigger recording to be initiated via the corresponding camera. Such a trigger and/or the recording taken thereafter via the camera may be provided to the first central control hub 110a as a security alert. Furthermore, in the party mode discussed herein, the security alert may additionally be provided to a different entertainment system than the entertainment system to which the camera belongs.

The GPS devices 115a may be wireless devices that are communicatively coupled to the hub 110a and may further be waterproof. The communication between the GPS devices 115a and the hub 110a may be established via satellite internet (e.g., Starlink), in at least one example. In one or more examples, an alert may be generated at the hub 110a responsive to receiving communication between one or more of the GPS devices 115a and the hub 110a. For example, the alert may be a location indication of the one or more GPS devices 115a. The GPS devices 115a may be two-way communication devices in one or more examples. In such examples, an alert may be additionally or alternatively be generated at the GPS devices 115a. For example, a user may provide an input at the hub 110a causing an alert to be generated at the GPS devices 115a. Via such GPS devices 115a, family, friends, and hunting parties may be able to track each other's locations.

Other devices may be included in addition to the above without departing from the scope of the present disclosure. For example, devices such as smart appliances (e.g., coolers, pizza ovens, grills, etc.), projectors, a retractable awning, integral systems such as on board diagnostic systems, and others may be connected to the hub 110a and controllable via the hub 110a without departing from the scope of the present disclosure. For example, a temperature of the smart appliances may be controlled via the hub 110a. Such temperature notifications may be used in a case of game temperature control. For example, a cooler with a temperature sensor may be communicatively coupled and configured to provide an alert via the hub when a temperature in the cooler is greater than a threshold temperature required for the game (e.g., fish). In examples where a retractable awning is included, the retractable awning may be automatically repositioned, in one or more examples. In particular, responsive to one or more conditions (wind greater than a threshold speed), a position of the retractable awning may be automatically adjusted.

For example, if the first entertainment system 120 and the second entertainment system 1220 were being operated in a party mode, then the security alert generated responsive to detection at the first camera 113a may be provided to the second entertainment system 1220 (e.g., to the second central control hub 110b of the second entertainment system 1220). In some examples, the cameras may be integral to a security system of the first RV 1004. Further, in addition to security cameras 113a and 113b, additional cameras may include satellite cameras used for imaging of a region. Such satellite imaging (e.g., via Starlink imaging) may enable a campsite unseen determination as to whether a campsite is available for use. For example, satellite imaging may be used to capture a region that includes one or more campsites. Then, based on such satellite imaging, a determination may be made as to whether any of the one or more campsites is available for use. In some examples, coverage from trees or other features may prevent a direct satellite image to be taken of one or more campsites of interest. In such cases, an estimated likelihood of campsite availability may be generated based on one or more factors, including one or more of weather patterns (e.g., snow, rain, fire, etc) and previous imaging of the area, for example. It is noted that global Wifi available for RVs and people on the go is provided via satellites (e.g., Starlink) that take photos as they fly by. Thus, by providing a status of campsite availability via such satellite internet, it is noted that a user may be able to monitor the availability of campsites in a more up-to-date manner without having to physically visit the campsite. Such satellite imaging may further be utilized for monitoring marine conditions, without departing from the scope of the present disclosure.

It is noted that more or fewer of any of such devices may form part of the first entertainment system 120 without departing from the scope of the present disclosure. The devices of the first entertainment system 120 may be associated with the first RV 1004. Thus, the first entertainment system 120 may also be referred to herein as the first RV entertainment system 120. In at least one example, the association of the first entertainment system 120 with the first RV 1004 may include a communicative connection between one or more devices of the first entertainment system 120, including the first central control hub 110a, and the first RV 1004. In this way, alerts may be generated via systems integral to the first RV 1004, such as one or more speakers or visual displays of the first RV 1004, for example.

A second entertainment system 1220 is further shown in FIG. 12 and may comprise one or more devices communicatively coupled to a second central control hub 110b, where the second central control hub 110b may be the same or similar to central control hub 110. For example, one or more of the torch 102b, fire pit 1006b, lights (including light 114b), water feature 1008b, speakers (including 112b), cameras (including camera 113a), and GPS devices 115b F may be communicatively coupled to the second central control hub 110b to form the second entertainment system 1220. It is further noted that more or fewer of any of such devices may form part of the second entertainment system 1220 without departing from the scope of the present disclosure. Similar to the first entertainment system 120, the devices of the second entertainment system 1220 may be associated with the second RV 1204. Thus, the second entertainment system 1220 may also be referred to herein as the second RV entertainment system 1220. In at least one example, the association of the second entertainment system 1220 with the second RV 1204 may include a communicative coupling between one or more devices of the second entertainment system 1220, including the second central control hub 110b, and the second RV 1204. In this way, alerts may be generated via systems integral to the second RV 1204 such as one or more speakers or visual displays of the second RV 1204, for example. There may be additional entertainment systems (including RV entertainment systems) in one or more examples. It is noted that the camera 113b of the second entertainment system 1220 may be the same or similar to camera 113a of the first entertainment system.

The one or more devices of the first entertainment system 120 and the one or more devices of second entertainment system 1220 may be operated in a first mode, also referred to herein as a standard mode. The standard mode is a non-party mode in which the entertainment system being operated in the standard mode is not coupled to another entertainment system. Alternatively, the one or more devices of the first entertainment system 120 and the one or more devices of the second entertainment system 1220 may be operated in a second mode, also referred to herein as party mode or a multi-link mode.

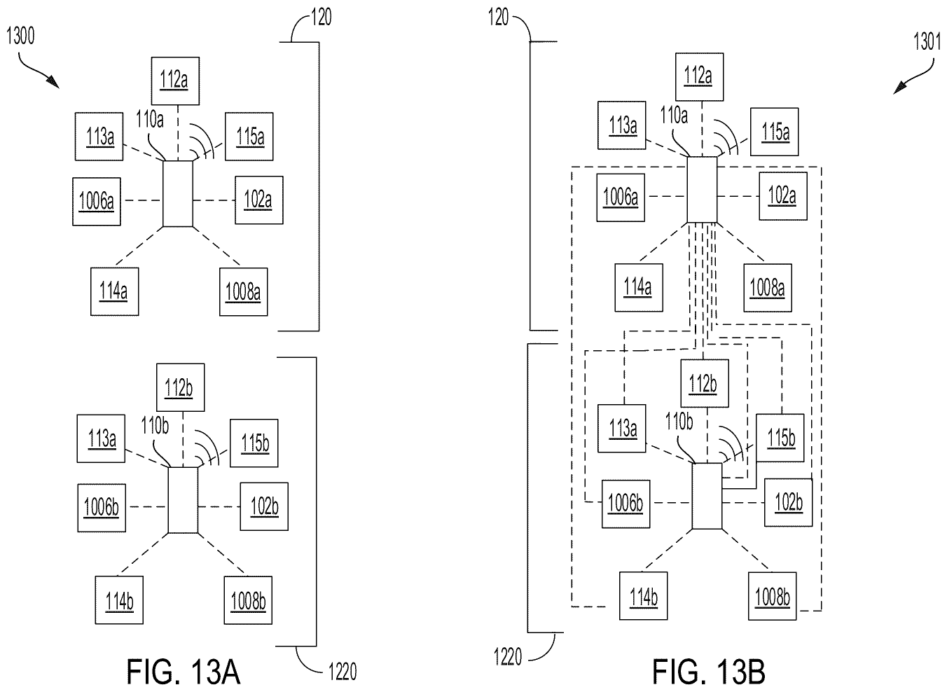

In the first mode (standard mode) the one or more devices of the first entertainment system 120 are communicatively connected to the first central control hub 110a, and the one or more devices of the second entertainment system 1220 are communicatively connected to the second central control hub 110b, and there may be no overlap in communication between the first entertainment system 120 and the second entertainment system 1220. That is, in the first mode (standard mode) none of the one or more devices of the first entertainment system 120 may be communicatively coupled to any of the one or more devices of the second entertainment system 1220, including the second central control hub 110b. In this way, there is complete separation in control of the one or more devices of the first entertainment system 120 and the one or more devices of the second entertainment system 1220. Attention is briefly directed to FIG. 13A, which shows a connectivity map for multiple entertainment systems operated in a first mode 1300 (also referred to herein as the standard mode). FIG. 13B shows a connectivity map for multiple entertainment systems operated in a second mode 1301. It is noted that communicative connections are represented by the dash lines.

As with previously discussed examples, the devices disclosed herein may be on a wireless network. Thus, the communicative connections shown in FIG. 13A and FIG. 13B may be wireless connections. For example, the communicative connections may be satellite enabled (e.g., Starlink) or a short range wireless connection (e.g., Bluetooth). The approach for establishing the wireless connections as discussed previously herein may be used to establish the wireless communicative connections at FIG. 13A and FIG. 13B. Additionally or alternatively, one or more of the communicative connections may be wired connections.

It is noted that there may be more or fewer devices in each of the first entertainment system 120 and the second entertainment system 1220 than illustrated in FIG. 13A and FIG. 13B. For example, in some cases, systems integral to the first RV 1004 may be coupled to the first central control hub 110a and/or systems integral to the second RV 1204 may be coupled to the second central control hub 110b, respectively. These systems integral to the first RV 1004 and/or the second RV 1204 may include one or more of a sound system integral to the RV, lighting integral to the RV, and visual display.

As seen in FIG. 13A, the one or more devices of the first entertainment system 120 are coupled to the first central control hub 110a, and the one or more devices of the second entertainment system 1220 are coupled to the second central control hub 110b. However, there is no communicative connection between the one or more devices of the first entertainment system 120 and the second entertainment system 1220. Rather, the first entertainment system 120 and the second entertainment system 1220 are communicatively separate from one another. Thus, the first entertainment system 120 and the second entertainment system 1220 are separately controlled.

Notably, the first entertainment system 120 and the second entertainment system 1220 may be on a same network in FIG. 13A. The lack of communicative connection between the first entertainment system 120 and the second entertainment system 1220 refers to the control of the first entertainment system 120 being carried out via only the first central control hub 110a, and the control of the second entertainment system 1220 being carried out via only the second central control hub 110b.

Turning to FIG. 13B, FIG. 13B shows operation of the first entertainment system 120 and the second entertainment system in a second mode (party mode). As seen in FIG. 13B, there is communicative coupling between the first entertainment system 120 and the second entertainment system 1220 in the party mode. In particular, each of the devices of the first entertainment system 120 and the second entertainment system 1220 are communicatively connected to the first central control hub 110a in the party mode. Such communicative connection between the first entertainment system 120 and the second entertainment system 1220 for the party mode requires that at least the first central control hub 110a and the second central control hub 110b are on the same network.

Additional communicative connections have also been contemplated for the party mode. For example, in addition to the connections shown in FIG. 13B, there may further be communicative connections from each of the one or more devices of the second entertainment system 1220 to the first central control hub 110a and/or communicative connections to one or more integrated systems of an RV. Further, as an alternative, there may be fewer communicative connections. For example, rather than coupling devices directly to the central control hub of another entertainment system, a communicative coupling may instead be established between the first central control hub 110a and the second central control hub 110b without the need for establishing further connections.

Once in the party mode as shown in FIG. 13B, the operational parameters for the one or more devices of both the first entertainment system 120 and the one or more devices of the second entertainment system 1220 are able to be controlled in a coordinated manner. For example, inputs received at the first central control hub 110a may be used to control operation of devices in both the first entertainment system 120 and the second entertainment system 1220. This control of devices in both the first entertainment system 120 and the second entertainment system 1220 may include coordinating audio output provided by speaker 112a in the first entertainment system 120 and speaker 112b in the second entertainment. For example, the speaker 112a and the speaker 112b may be controlled to provide a same audio output in a synchronized manner. It is noted that operation as previously discussed for coordinating control of a single entertainment system may be applied to control both the first entertainment system 120 and the second entertainment system 1220 in the party mode. In this way, a larger entertainment display may be flexibly created.

Further, in at least one example, the party mode may further be used to trigger displays responsive to outputs from devices in another entertainment system. For example, in the party mode where there is combined control of the first entertainment system 120 and the second entertainment system 1220, receiving an output from one or more of the devices from the first entertainment system 120 may trigger a response for one of the one or more devices of the second entertainment system 1220. For example, responsive to one or more lights (e.g., light 114a) of the first entertainment system 120 detecting an object or person within a threshold distance of the light 114a, an alert may be generated via both the first entertainment system 120 and the second entertainment system. For example, the alert may include a visual alert and/or an audio alert. The visual alert may include illuminating one or more of the lights (such as light 114a) at a predetermined brightness. In some examples, only the lights that detected the object or person may be illuminated. This may assist with viewing the location of where the object or person was detected. However, in at least one example, all of the lights may be illuminated to the predetermined brightness responsive to the detection of the object or person.

In addition to or as an alternative to the visual alert being the illumination of one or more of the lights, it is also noted that the visual alert may be a message provided via one or both of the first central control hub 110a and the second central control hub 110b. In examples where an audio alert is provided, the audio alert may be provided via one or more of the central control hub 110a, the second central control hub 110b, and the speakers (e.g., speaker 112a, speaker 112b). In this way, alerts may be shared across both the first entertainment system 120 and the second entertainment system 1220 in the party mode. In contrast, in examples where the first entertainment system 120 and the second entertainment system 1220 are operated in the standard mode, the audio and/or visual alert provided responsive to the one or more lights (e.g., light 114a) detecting the object or person would only result in alerts at devices in the same entertainment system. Thus, if light 114a from the first entertainment system 120 detected the object or person, then the alert would only be generated via one or more devices of the first entertainment system 120 (e.g., first central control hub 110a, speaker 112a, systems of the first RV 1004).

It is noted that although RVs are shown in FIG. 12, it is also possible that the entertainment systems disclosed at FIGS. 12-13B may be entertainment systems for one or more of boats and trailers.

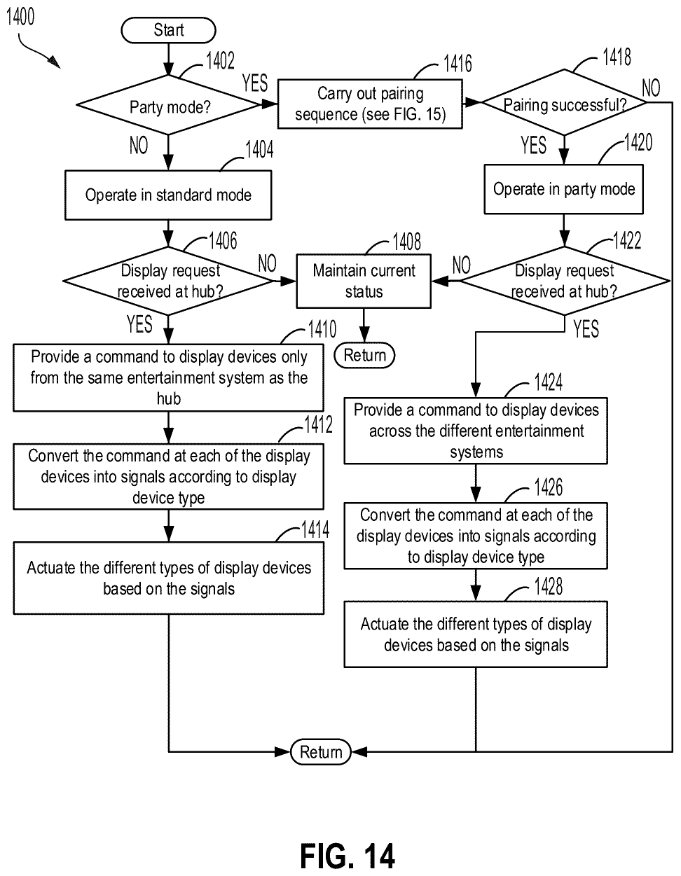

Turning now to FIG. 14, FIG. 14 shows an example method 1400 for operating one or more entertainment systems, such as the first or second entertainment system 120, 1220. In at least on example, the method 1400 for operating the one or more entertainment systems may be carried out via the entertainment systems discussed at FIG. 12, e.g. the first and/or second entertainment systems 120, 1220. For example, the one or more entertainment systems may include a first entertainment system that is similar or the same as the first entertainment system 120. Thus, one or more of the devices and features discussed as to the first entertainment system 120 may be included in the first entertainment system of the method. The one or more entertainment systems may further include a second entertainment system that is similar to or the same as the second entertainment system 1220. Thus, one or more of the devices and features discussed as to the second entertainment system 1220 may be included in the second entertainment system of the method described at FIG. 14. Additional entertainment systems may be included without departing from the scope of the present disclosure. It is noted that such additional entertainment systems may include the same or similar devices as are disclosed for the first entertainment system 120 and the second entertainment system 1220.

The method may be executed by the devices of the one or more entertainment systems via instructions stored in non-transitory memory of the devices. For example, a first central control hub (similar or the same as the first central control hub 110a) may store instructions in non-transitory memory to carry out the method 1400. Via the instructions stored in non-transitory memory of the first control hub, one or more outputs may be generated responsive to signals received at the first central control hub. The one or more outputs generated may be received at one or more entertainment system devices to actuate such one or more entertainment system devices.

Turning now to step 1402, step 1402 includes determining whether or not a party mode is requested. In one or more examples, it may be determined that the party mode is requested responsive to receiving a user input at the first central control hub of the first entertainment system. The user input may be received via a user interface of a mobile device (e.g., touch screen, voice command, etc.), where the mobile device serves as the first central control hub, for example.

Requesting the party mode at step 1402 is a request to access party mode set-up. The party mode may be an operational mode in which multiple entertainment systems are communicatively coupled to enable coordinated actuation of devices across the multiple entertainment systems. All devices in one of the multiple entertainment systems may be assigned to a corresponding central control hub. For example, all of the devices of the first entertainment system may be assigned to the first central control hub, and all of the devices of the second entertainment system may be assigned to the second central control hub. In cases where there is a third entertainment system, all devices of the third entertainment system may further be assigned to a third central control hub, and so forth. The devices of the entertainment systems may include one or more of the devices disclosed for the entertainment systems herein (e.g., the devices of the first entertainment system 120 and the second entertainment system 1220).

Responsive to determining that the party mode is not requested at step 1402, method 1400 proceeds to step 1404 to operate the first entertainment system in the standard mode. While operating the first entertainment system in the standard mode, method 1400 includes determining whether or not a display request has been received at the first central control hub (e.g., first central control hub 110a) at step 1406. The display request may be a request for display devices of the first entertainment system to provide a display. For example, the display request may include a request for the display devices to provide a display coordinated to an audio input, such as music. In one or more examples, the first central control hub may be a mobile device or other personal computing device. Thus, determining whether or not a display request has been received may include determining whether or not a user input has been received via an application of the mobile device to provide a display request. If it is determined that no display request has been received, then method 1400 proceeds to step 1408 to maintain a current status for the first central control hub and all display devices of the first entertainment system. Following step 1408, method 1400 returns.

If it is determined that a display request has been received at step 1406, then method 1400 proceeds to step 1410. It may be determined that a display request has been received responsive to detecting a user input. The user input may be received via the hub, such as through an application on a mobile device, in at least one example. The display request may be a request for display devices of the first entertainment system to provide a display coordinated to an audio input, in at least one example.

At step 1410, method 1400 includes providing a command from the first central control hub only to display devices of the first entertainment system. In particular, step 1410 may include providing a command from the first central control hub to different types of display devices only within the same, first entertainment system as the first central control hub. The command may include the audio input, in at least one example. It is noted that the same command may be provided to the display devices of the first entertainment system.

Following step 1410, method 1400 proceeds to step 1412. As step 1412, each of the display devices that received the command from step 1410 converts the command into signals based on the display device type. In particular, the network-based controller (e.g., network-based controller 1010) for each of the devices that received the command converts the command into signals for actuating the device based on the particular display device type. For example, a first display device that receives the command may be a fire only device (e.g., torches 102) and a second display device that receives the command may be a combination fire and audio device (e.g., fire pit 1006). Thus, although the same command is received at both the first display device and the second display device in this example, the respective network-based controller in each of the first display device and the second display device will convert this same command into different signals based on the different device types. In this example, the first display device (fire only) may convert the command into signals for actuating one or more valves and/or an ignitor based on the command without any audio actuation commands. The second display device (a combination fire and audio), in contrast, may convert the command into signals for both actuating one or more valves and/or an ignitor, as well as actuating a speaker based on the command. In a case where the command is an audio command, it is noted that both the signals for the first display device and the second display device will be coordinated to the audio command.

Following step 1412, method 1400 proceeds to step 1414. At step 1414, the different types of display devices are actuated based on the signals converted from the command at step 1412. In this way, using the same command (e.g., an audio command such as music), different types of display devices may be operated. As a result, different types of display devices of the first entertainment system are able to be actuated in coordination to the same command output from the first central control hub.

In some examples, the user input may include instructions for only a portion of the active display devices of the one or more display devices. For example, the active display devices may include fire devices and lighting devices but a user may choose to only operate the fire devices and the lighting devices may remain in a stand-by mode, or the user may select only a portion of the fire devices and/or a portion of the lighting devices to be operated. Furthermore, as described above, the one or more display devices may be grouped into channels, which may be assigned by the user or automatically selected and assigned based on device type, communication mode, etc. The user may input commands to one of the channels, all of the channels, or a portion of the channels.

As another example, the first central control hub may receive an audio input via a hard-wired connection (e.g., a cable coupled to an aux in port of the control hub) or by a wireless connection, where the audio input may be, for example, music provided by a mobile device or an audio device, such as a device for playing audio files. The audio input may also be an audio selection indicated and chosen by the user at the user interface of the control hub. The user input may further include a request for the operation of the active display devices to be synchronized to the audio input. Operating parameters of the active display devices may therefore be adjusted according to the audio input as determined and monitored by audio receivers of the control hub, e.g., audio receivers configured to read and interpret an audio file delivered by the audio input and/or detect and monitor audio effects of the audio input (e.g., frequency, volume, rhythm, etc.) as the audio input is translated to sound broadcasted by the audio display devices. For example, flame intensity at the fire devices, water flow at the water feature devices, and light intensity/color at the lighting devices may be pulsed and varied to provide visual effects of the entertainment system that complement the audio effects.

In this way, networked display devices of the first entertainment system may be coordinated in a simple manner. It is noted that reference to signals, such as input signals, output signals, and control signals, refer to electric signals, in at least one example. The signals may be transmitted and received at a first central control hub of the first entertainment system, the first central control hub configured to communicate with the display devices via a variety of communication modes. The first central control hub may provide centralized, customizable control of the entertainment system, thereby allowing a user to adjust all display devices connected to the first central control hub of the first entertainment system easily, e.g., without specialized knowledge or skill, and efficiently. Following step 1414, method 1400 then returns.

Looking back to step 1402, responsive to determining that the party mode is requested at step 1402, the method proceeds to step 1416.

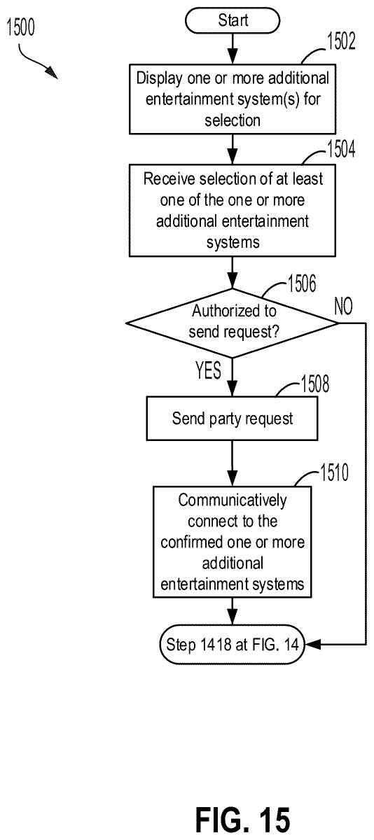

At step 1416, a pairing sequence is carried out to pair the first entertainment system to one or more additional entertainment systems for operation in the party mode. Turning briefly to FIG. 15, details as to an example pairing sequence method 1500 are shown.

The example method 1500 may include displaying the one or more additional entertainment systems on the first central control hub for selection by the user at step 1502. Such selection is to send a party request to such one or more additional entertainment systems, where the party request is a request to join for the party mode. The one or more additional entertainment systems displayed for selection may be entertainment systems that are detected on a same wireless network as the first entertainment system (including the first central control hub). Though on the same wireless network, it is noted that the one or more additional entertainment systems are not yet communicatively linked to the first entertainment system at step 1502. That is, the one or more additional entertainment systems and the first entertainment system are not able to send device control commands across entertainment systems. Rather, device communication for the one or more additional entertainment systems is separate from the device communication within the first entertainment system, similar to the example shown at FIG. 13A. The one or more additional entertainment systems are simply visible to the first entertainment system via the wireless network. It is noted that the wireless network may be enabled via satellite internet (e.g., Starlink) or other wireless connection means (e.g., Bluetooth).

The display of the one or more additional entertainment systems may be provided on a display screen, such as a touch screen, of the first central control hub. The one or more additional entertainment systems displayed may include a second entertainment system and a third entertainment system, for example. More or fewer entertainment systems may be displayed for selection without departing from the scope of the disclosure. It is noted that the one or more entertainment systems may be similar to or the same as the other entertainment systems disclosed herein (e.g., the first entertainment system 120 and the second entertainment system 1220).

It is further noted that the one or more entertainment systems displayed for selection may include individual display devices or another party for selection. That is, it is possible for there to be an individual device (e.g., a fire pit, water device, speaker, camera, etc.) that is not assigned to the first central control hub displayed for selection at step 1502. It is also possible for an existing party comprising multiple entertainment systems that are already communicatively linked and being operated in the party mode together. Thus, displaying the one or more additional entertainment systems during the pairing sequence at step 1502 may include displaying one or more existing parties.

Following step 1502, the method 1500 may include receiving selection of at least one of the one or more additional entertainment systems at step 1504. For example, a user input may be received at the first central control hub (e.g., user input to a touch screen, voice command, etc.). Responsive to the selection of the one or more additional entertainment systems at step 1504, the method 1500 may proceed to step 1506.

At step 1506, the method 1500 determines whether or not the first central control hub is authorized to initiate the request. For example, authorization may include detecting whether or not the first central control hub has permission to modify a party. The permission to modify the party may be a predetermined status assigned to one or more central control hubs. In a case where the first central control hub is already part of an existing party, only one of the multiple central control hubs (e.g., one of the first central control hub, second central control hub, etc.) may have permission to modify the party. Additionally or alternatively, authorization may include requiring a user passcode. Further, in one or more examples, the authorizing at step 1506 may additionally or alternatively include obtaining party approval. Such party approval may be obtained by sending a request to one or more other central control hubs to approve the party request to be sent. In some cases, party approval may only require approval from one central control hub with permission to send party requests. In other cases, a majority or all central control hubs of the party may need to provide approval in order to send party requests. In this way, improved control may be maintained over which entertainment systems are added to a party.

If authorization is not received to send the party request at step 1506, method 1500 proceeds to step 1418 at FIG. 14. Not receiving authorization to send the party request may include a threshold amount of time elapsing after a request for authorization is sent (e.g., a party approval request is sent and/or a password request is sent) without response. Additionally or alternatively, it may be determined that authorization is not received at step 1506 responsive to receiving a denial of the party approval request from one or more the central control hubs. In at least one example, it may be determined that authorization is not received if an incorrect password is entered more than a predetermined threshold number of times. Additionally or alternatively, it may be determined that the party request is not authorized at step 1506 responsive to detecting that the first central control hub attempting to make the party request does not have permission to make party modifications.

If authorization is received to send the party request at step 1506, method 1500 proceeds to send the party request at step 1508. In particular, the party request is sent to the one or more additional entertainment systems selected at step 1504. Receiving authorization to send the party request at step 1506 may include one or more of obtaining party approval from one or more of the central control hubs, receiving entry of a correct password, and detecting that the first central control hub attempting to make the party request has permission to make party modifications, for example.

Following step 1508, method 1500 includes communicatively connecting the first entertainment system to any of the one or more additional entertainment systems from which a confirmation to join the party is received at step 1510. That is, method 1500 may include receiving a confirmation from at least one of the one or more additional entertainment systems to join the party, and communicatively connecting the first entertainment system to the at least one of the one or more additional entertainment systems from which the confirmation was received. Communicatively connecting the first entertainment system to the at least one of the one or more additional entertainment systems enables control signals to be shared between the first entertainment system and these other entertainment systems. In this way, reference to a communicative connection discussed herein may refer to a connection which allows for device control commands in the form of electronic signals to be sent between entertainment systems. Thus, the communicative connections may also be referred to herein as device control connections. For example, without establishing a communicative connection between the first entertainment system and one or more of the additional entertainment systems, the first central control hub of the first entertainment system is only able to actuate devices of the first entertainment system. Though the first entertainment system may be able to ping the central control hubs of the one or more additional entertainment systems (e.g., to send a party request) without establishing a communicative connection, the first entertainment system is unable to control any devices (e.g., fire devices, speakers, water devices, lighting devices, etc.). After the first entertainment system is communicatively coupled with at least one of the one or more additional entertainment systems, however, device control commands are able to be shared between entertainment systems. Thus, the first entertainment control system may be able to send control commands to control one or more devices of the communicatively connected entertainment systems. Additionally or alternatively, devices of the first entertainment system are able to be actuated via control commands received from the one or more additional entertainment systems to which the first entertainment system is communicatively coupled.

The confirmation to join is a response received from the one or more additional entertainment systems (e.g., central control hubs of the one or more additional entertainment systems) indicating that communicative connection to the one or more additional entertainment systems is authorized. The confirmation to join may be received at the first central control hub from the corresponding central control hubs of the one or more additional entertainment systems. For example, the confirmation may be sent responsive to a user input at the one or more additional entertainment systems to which the party request was sent.

Method 1500 further includes not communicatively connecting the first entertainment system to any of the one or more additional entertainment systems for which confirmation to join the party was not received. It may be determined that confirmation to join the party is not received responsive to lack of response for greater than a predetermined threshold time or receiving a denial to join the party. In cases where confirmation to join the party is not received from any of the one or more additional entertainment systems, method 1500 proceeds to step 1418 at FIG. 14 without establishing any communicative connections between the first entertainment system and the one or more entertainment systems to which the party request was sent.

Following step 1510, method 1500 proceeds to 1418 of FIG. 14. Thus, turning back now to FIG. 14, at step 1418 it is determined whether or not pairing is successful. The pairing is successful if there is at least one of the one or more additional entertainment systems that successfully established a communicative connection with the first entertainment system. If none of the one or more additional entertainment systems established a communicative connection with the first entertainment system, method 1400 proceeds from step 1418 to return.

Responsive to detecting that at least one of the one or more entertainment systems that successfully established a communicative connection with the first entertainment system, method 1400 proceeds from step 1418 to step 1420. At step 1420, the first entertainment system, as well as the additional entertainment systems communicatively coupled thereto, are operated in party mode. During operation in party mode, it is noted that device control commands are shared between the entertainment systems as described at FIG. 13B. In this way, coordinated control is enabled across the different entertainment systems, enabling larger entertainment experiences to be created in a simplified manner. This may be particularly useful in the case of multiple RVs linking entertainment systems together at an event to create a larger, coordinated entertainment experience in an efficient manner.

For example, in the party mode when multiple entertainment systems are linked together, lights may be lit from a first entertainment system and continue onto another entertainment system. Such continuation of lighting may be responsive to the detection of an object or body passing by the lights and may, in addition to serving as entertainment, provide a lit path.

While operating the entertainment systems in the party mode, method 1400 comprises determining whether a display request is received at one of the central control hubs at step 1422. For example, method 1400 includes determining whether or not there is a display generated by any of the central control hubs of the entertainment systems communicatively connected in the party mode. The display request may be a request for one or more display devices of the multiple entertainment systems communicatively connected in the party mode to provide a display. For example, the display request may include a request for the display devices to provide a display coordinated to an audio input, such as music.

If it is determined that a display request has been received at step 1422, then method 1400 proceeds to step 1424. It may be determined that a display request has been received responsive to detecting a user input. The user input may be received via one of the central control hubs of the entertainment systems communicatively connected in the party mode (e.g., the first central control hub, the second central control hub, etc.). In some examples, the user input may be provided via an application on one of the central control hubs. The display request may be a request for display devices of one or more of the first entertainment system and the one or more additional entertainment systems communicatively coupled thereto to provide a display. The display request may be to actuate devices across multiple, different entertainment systems that are being operated together in the party mode. For example, the display request may include a request for coordinated fire displays via fire devices across different entertainment systems. Additionally or alternatively, the display request may include a request for different types of devices (e.g., fire, water, lighting, audio) across different entertainment systems to provide a coordinated display, such as a multi-entertainment system display coordinated to an audio input that is the same audio input.

At step 1424, method 1400 includes providing a command to display devices across the different entertainment systems being operated together in the party mode. For example, step 1424 may include providing a command from the first central control hub to different types of display devices across the different entertainment systems. The command may include an audio input, in at least one example. It is noted that the same command may be provided to the display devices of the different entertainment systems.

Following step 1424, method 1400 proceeds to step 1426. As step 1426, each of the display devices that received the command from step 1424 converts the command into signals based on the display device type. In particular, the network-based controller (e.g., network-based controller 1010) for each of the devices that received the command converts the command into signals for actuating the device based on the particular display device type. For example, a first display device that receives the command may be a fire only device (e.g., torches 102) and a second display device that receives the command may be a combination fire and audio device (e.g., fire pit 1006). Thus, although the same command is received at both the first display device and the second display device in this example, the respective network-based controller in each of the first display device and the second display device will convert this same command into different signals based on the different device types. In this example, the first display device (fire only) may convert the command into signals for actuating one or more valves and/or an ignitor based on the command without any audio actuation commands. The second display device (a combination fire and audio), in contrast, may convert the command into signals for both actuating one or more valves and/or an ignitor, as well as actuating a speaker based on the command. In a case where the command is an audio command, it is noted that both the signals for the first display device and the second display device will be coordinated to the audio command.

Following step 1426, method 1400 proceeds to step 1428. At step 1428 the different types of display devices are actuated based on the signals converted from the command at step 1426. In this way, using the same command (e.g., an audio command such as music), different types of display devices may be operated. As a result, different types of display devices of the first entertainment system are able to be actuated in coordination to the same command output from the first central control hub.

Via the methods and systems described herein, RV and tailgate setups may serve as a concert. For example, an outdoor enthusiast could collect multiple fire devices (e.g., six tiki torches), two portable speakers, a fire pit, multiple lanterns, and one string of sting lights can provide a camper's everyday need for light, audio, and fire. All controlled by the hub discussed herein. When it's time to entertain, the connect button may be pressed at the hub and/or on the relevant devices and the products will link together to form one or more of an audio show, fire show, light show, and multi-trailer party. Connectable device functions may be controlled from inside the RV (via the hub) or on the device itself. It is noted that the devices are selectively connectable. Thus, it is possible to connect to just the string lights and enjoy the ease of turning the lights on from inside the trailer or RV. In another example, multiple lanterns may be hung in a camp, directing tent campers to the outside water closet controlled from the comfort of inside the trailer or RV. Connect multiple trailers and sync your camps music through each trailer for an ultimate party. In a further example, a fire pit may be displayed and shoot flames to music.

It is noted that control of the multiple entertainment systems in the party mode and/or an entertainment system in a standard operating mode (not coordinated with another entertainment system) may include adjusting various devices in response to one another.

For example, in a case where there is a retractable awning, the retractable awning may be automatically retracted responsive to one or more weather conditions. The one or more weather conditions may include wind greater than a threshold speed. Such one or more conditions for adjusting the position of the retractable awning(s) may further inform additional adjustments for one or more of the entertainment systems. For example, responsive to adjusting the position of the retractable awning, a different device of the same entertainment system or an entertainment system coupled in the party mode may be adjusted. This may include turning off one or more fire devices responsive to retracting one of the retractable awnings due to wind greater than the threshold speed. Other weather conditions may further be used to automatically turn off one of more fire devices, such as detecting rain conditions, for example.

As another example, one or more of the lighting devices (e.g. lanterns) may comprise sensors to detect whether a person is present. Responsive to not detecting a person present for greater than a threshold period of time, the lighting devices may gradually dim their light brightness (including turning off their light or dimming to a predetermined low level of brightness, in one or more examples). This dimming operation may preserve a battery life of the lighting devices. An example of such auto-dimming lanterns 1600 are shown at FIG. 16, for example. The auto-dimming lanterns 1600 are shown as part of a schematic 1602. The components comprising the auto-dimming lanterns 1600 are shown approximately to scale relative to the auto-dimming lanterns 1600. The auto-dimming lanterns 1600 are shown schematically relative to other components, features, or objects in the schematic 1602. The schematic may comprise an input device 1604, such as a button. When selected, the input device 1604 may send a single to communicatively couple the electronic components, such as a sensor 1606 and the auto-dimming lanterns 1600 to one another. The sensor 1606 may detect an object, such as a person 1610. As an example, when the person 1610 or another object is detected by the sensor 1606, and the sensor 1606 is communicatively coupled to the auto-dimming lanterns 1600, one or more of the auto-dimming lanterns 1600 may increase in luminosity. For this or another example, sensor 1606 and auto-dimming lanterns 1600 may be responsive to not detecting a person, such as person 1610, for a period greater than a threshold period of time. When the threshold period of time is exceeded for communicatively coupled sensors, such as sensor 1606, the auto-dimming lanterns 1600 may enter a standby mode, where one or more lanterns may decrease in luminosity. Furthermore, responsive to not detecting a person, such as the person 1610, for greater than the threshold period of time, a standby mode may be entered where one or more other devices of the same or different entertainment system may be adjusted. For example, one or more of a volume of one or more speakers (including those integral to an RV sound system) may be decreased to less than a threshold level (including turned off, in at least one example), fire device(s) may be turned off, and water device(s) may be turned off. The afformentioned device(s) may be controlled by a controller. For example, sensors, such as sensor 1606, may be communicatively coupled with a controller. For based on signals from the sensor 1606, the controller may make decisions based on data, such as if a person or object is detected or if a person or object has not been detected for a period of time greater than a threshold period of time. The controller may control devices based on the data from the sensors. For example, the controller may send a command signal to the auto-dimming lanterns 1600 to increase in luminosity. For another example, the controller may a send command signal to the auto-dimming lanterns 1600 to decrease in luminosity.

In yet still another example, GPS devices and their respective hubs on board boats may be used to output boat positioning across multiple boat entertainment systems. That is, the positioning of boats with the GPS devices may be provided to multiple boat entertainment systems. Such a configuration may be useful for both navigation purposes and to potentially link the boats to create an on-water, multiple boat entertainment. For example, the GPS devices may be used to determine a position of the boats relative to one another to more easily gather for entertainment purposes. Then, in a party mode in which the entertainment systems of multiple boats are linked, the position of the boats relative to one another determined based on the GPS devices may be used to adjust a timing for actuating lighting devices of the multiple boats linked in the party mode to music in an aesthetically pleasing and entertaining manner, for example.

In some examples, the user input may include instructions for only a portion of the active display devices of the one or more display devices. For example, the active display devices may include fire devices and lighting devices but a user may choose to only operate the fire devices and the lighting devices may remain in a stand-by mode, or the user may select only a portion of the fire devices and/or a portion of the lighting devices to be operated. Furthermore, as described above, the one or more display devices may be grouped into channels, which may be assigned by the user or automatically selected and assigned based on device type, communication mode, etc. The user may input commands to one of the channels, all of the channels, or a portion of the channels.

As another example, the first central control hub may receive an audio input via a hard-wired connection (e.g., a cable coupled to an aux in port of the control hub) or by a wireless connection, where the audio input may be, for example, music provided by a mobile device or an audio device, such as a device for playing audio files. The audio input may also be an audio selection indicated and chosen by the user at the user interface of the control hub. The user input may further include a request for the operation of the active display devices to be synchronized to the audio input. Operating parameters of the active display devices may therefore be adjusted according to the audio input as determined and monitored by audio receivers of the control hub, e.g., audio receivers configured to read and interpret an audio file delivered by the audio input and/or detect and monitor audio effects of the audio input (e.g., frequency, volume, rhythm, etc.) as the audio input is translated to sound broadcasted by the audio display devices. For example, flame intensity at the fire devices, water flow at the water feature devices, and light intensity/color at the lighting devices may be pulsed and varied to provide visual effects of the entertainment system that complement the audio effects.

In this way, networked display devices of multiple entertainment systems may be coordinated in a simple manner. It is noted that reference to signals, such as input signals, output signals, and control signals, refer to electric signals, in at least one example. The signals may be transmitted and received via central control hubs of the entertainment systems, the central control hubs configured to communicate with the display devices via a variety of communication modes. The central control hubs may provide centralized, customizable control of the multiple entertainment systems, thereby allowing a user to adjust all display devices across the different, multiple display systems system easily, e.g., without specialized knowledge or skill, and efficiently and in a coordinated manner. Following step 1428, method 1400 then returns.

The disclosure also provides support for a method, comprising: communicatively connecting a central control hub of a first entertainment system to one or more display devices of a second entertainment system, and actuating the one or more display devices of the second entertainment system via the central control hub. In a first example of the method, the first entertainment system and the second entertainment system are recreational vehicle (RV) entertainment systems. In a second example of the method, optionally including the first example, the one or more display devices include one or more of a water device, a fire device, a lighting device, a camera, and an audio device. In a third example of the method, optionally including one or both of the first and second examples, the method further comprises: actuating one or more display devices of the first entertainment system via the central control hub. In a fourth example of the method, optionally including one or more or each of the first through third examples, the central control hub is a first central control hub, and wherein the second entertainment system comprises a second central control hub. In a fifth example of the method, optionally including one or more or each of the first through fourth examples, the one or more display devices of the second entertainment system are assigned to the second central control hub, and wherein the first entertainment system comprises one or more display devices assigned to the first central control hub. In a sixth example of the method, optionally including one or more or each of the first through fifth examples, the communicative connection is established via satellite internet. The disclosure also provides support for a method, comprising: detecting a request to operate both a first entertainment system and one or more additional entertainment systems in a party mode, communicatively connecting a first central control hub of the first entertainment system to the one or more additional entertainment systems, and actuating one or more display devices of the first entertainment system and the one or more additional entertainment systems via the first central control hub. In a first example of the method, communicatively connecting the first central control hub to the one or more additional entertainment systems includes enabling the first central control hub to actuate devices of the first entertainment system and the one or more additional entertainment systems. In a second example of the method, optionally including the first example, the first entertainment system and the one or more additional entertainment systems comprise different types of devices. In a third example of the method, optionally including one or both of the first and second examples, the different types of devices include two or more of fire devices, water devices, audio devices, and lighting devices. In a fourth example of the method, optionally including one or more or each of the first through third examples, the method further comprises: actuating at least one device from the one or more additional entertainment systems via a common control signal, via the first control hub. In a fifth example of the method, optionally including one or more or each of the first through fourth examples, the method further comprises: actuating at least one device of the first entertainment system, via the first control hub. In a sixth example of the method, optionally including one or more or each of the first through fifth examples, a common signal is used to actuate the at least one device from the one or more additional entertainment systems and the at least one device of the first entertainment system. In a seventh example of the method, optionally including one or more or each of the first through fifth examples, the at least one device from the one or more additional entertainment systems and the at least one device of the first entertainment system comprise different types of devices. In an eighth example of the method, optionally including one or more or each of the first through seventh examples, the common signal is converted once received at the at least one device from the one or more additional entertainment systems and the at least one device of the first entertainment system. In a ninth example of the method, optionally including one or more or each of the first through eighth examples, devices of the first entertainment system are assigned to the first central control hub, wherein each of the one or more additional entertainment systems comprises a corresponding central control hub, and wherein devices of each of the one or more additional entertainment systems are assigned to the corresponding central control hub. In a tenth example of the method, optionally including one or more or each of the first through ninth examples, first entertainment system and the one or more additional entertainment systems are RV entertainment systems. The disclosure also provides support for a system, comprising: a central control hub, one or more devices of a first entertainment system assigned to the central control hub, one or more devices of a second entertainment system not assigned to the central control hub, and instructions stored in non-transitory memory of the central control hub that are executable to: during operation of the central control hub in a party mode, communicatively connect the central control hub to the one or more devices of the second entertainment system, and actuate the one or more devices of the first entertainment system and actuate the one or devices of the second entertainment system via the central control hub. In a first example of the system, the instructions are further executable to: during operation of the central control hub in a standard mode, only actuate the one or more devices of the first entertainment via the central control hub, and to not actuate the one or more devices of the second entertainment system via the central control hub.

The disclosure also provides support for a method for operating an entertainment system, comprising: receiving user input at a central control hub communicatively coupled to one or more display devices, the user input including instructions for adjusting operating parameters of the one or more display devices of the entertainment system, the one or more display devices including one or more of speakers, fire devices, lighting devices, and water feature devices, converting the instructions into one or more signal transmission modes at the central control hub, the one or more signal transmission modes corresponding to communication modes of the one or more display devices, and delivering the instructions to the one or more display devices from the central control hub via the communication modes of the one or more display devices to output a display at the one or more display devices, the display including visual and/or audio displays, based on the instructions. In a first example of the method, adjusting the operating parameters of the one or more display devices includes adjusting the operating parameters to synchronize operation of the one or more display devices to an audio input, and wherein the audio input is one or more of an audio signal received through an aux in port of the central control hub and an audio signal received at the central control hub through a wireless communication link. In a second example of the method, optionally including the first example, adjusting the operating parameters to synchronize the operation of the one or more display devices includes one or more of varying a flame intensity of fire devices, a lighting effect of lighting devices, and a flow of water through water feature devices, according to audio effects of the audio input. In a third example of the method, optionally including one or both of the first and second examples, receiving the user input at the central control hub includes receiving user input at a user interface of the central control hub, and wherein the user interface is configured to receive the user input via one or more of touch, sound, and gestures. In a fourth example of the method, optionally including one or more or each of the first through third examples, converting the instructions into one or more signal transmission modes includes converting the instructions into hard-wired transmission modes and wireless transmission modes. In a fifth example of the method, optionally including one or more or each of the first through fourth examples, delivering the instructions to the one or more display devices includes delivering the instructions via one or more of a communication cable, a local wireless network, a Bluetooth connection, and a radiofrequency channel. In a sixth example of the method, optionally including one or more or each of the first through fifth examples, delivering the instructions to the one or more display devices includes transmitting the instructions via wireless transmitters of the central control hub when the one or more signal transmission modes includes the wireless transmission modes. In a seventh example of the method, optionally including one or more or each of the first through sixth examples, the method further comprises: receiving the instructions at receivers of each of the one or more display devices. In a eighth example of the method, optionally including one or more or each of the first through seventh examples, receiving the user input includes receiving the user input as instructions for groups of the one or more display devices to groups, and wherein the one or more display devices are assigned to the groups by one of user selection or automatic selection according to display device type. The disclosure also provides support for an entertainment system, comprising: a network, including, one or more display devices, the one or more display devices including audio display devices and visual display devices, a control hub communicatively coupled to the one or more display devices via one or more communication modes, the control hub configured to relay signals to coordinate operation of the one or more display devices in response to user input received at the control hub. In a first example of the system, the audio display devices include speakers and the visual display devices includes fire pits, fire torches, water feature devices, and lighting devices. In a second example of the system, optionally including the first example, the control hub is a mobile device. In a third example of the system, optionally including one or both of the first and second examples, the control hub includes a user interface communicatively coupled to a base, and wherein user interface is communicatively coupled to the base via one or more of a hard-wired connection and a wireless connection. In a fourth example of the system, optionally including one or more or each of the first through third examples, the user interface is a tablet with a display screen and wherein the display screen is configured to receive the user input by one or more of touch, sound, and detection of movement. In a fifth example of the system, optionally including one or more or each of the first through fourth examples, control parameters of the one or more display devices are displayed at the display screen and configured to be adjustable at the display screen by the user input. In a sixth example of the system, optionally including one or more or each of the first through fifth examples, the control hub is configured to receive an audio input and, in response a request from a user to synchronize operation of the one or more display devices to the audio input, to relay instructions to the one or more display devices to coordinate adjustments to operating parameters of the one or more display devices to the audio input. In a seventh example of the system, optionally including one or more or each of the first through sixth examples, the audio input includes one or more of an audio signal received through an aux in port of the control, and an audio signal received through a wireless communication link between the control hub and another device. The disclosure also provides support for a method for providing audio and visual entertainment, comprising, responsive to user input received at a central control hub, sending the user input to one or more display devices communicatively coupled to the central control hub via one or more communication modes to synchronize operation of the one or more display devices to an audio input. In a first example of the method, sending the user input to the one or more display devices includes sending instructions for pre-set programs provided by a subscription service for operating the one or more display devices. In a second example of the method, optionally including the first example, sending the user input to the one or more display devices includes one or more of sending individual operating instructions for each of the one or more display devices and sending instructions for operating groups of the one or more display devices. The disclosure also provides support for a multi-media display system, comprising, a hub, a first display device comprising a first network-based controller, and a second display device comprising a second network-based controller, wherein the first display device, the second display device, and the hub are on a network, wherein the first display device is a different type of display device than the second type of display device, and wherein the first network-based controller comprises instructions stored in non-transitory memory that when executed cause the first network-based controller to: receive a command from the hub that includes an audio input, convert the command into first display device signals that are based on the audio input, and actuate the first display device based on the first display device signals, wherein the first display device signals are different than second display device signals, and wherein the second display device signals are converted from the same command and are based on the same audio input as the first display device signals. In a first example of the system, the first display device is a fire display device. In a second example of the system, optionally including the first example, the second display device is one of an audio only device, a water device, and a lighting device. In a third example of the system, optionally including one or both of the first and second examples, the first display device is a fire only display device, and wherein the second display device is one or more of an audio device, a water device, and a lighting device. In a fourth example of the system, optionally including one or more or each of the first through third examples, the first display device is a single type display device, and wherein the second display device is a combination type display device. In a fifth example of the system, optionally including one or more or each of the first through fourth examples, the first display device is a fire only display device, and wherein the second display device is a combination fire and audio device. The disclosure also provides support for a method, comprising: receiving an audio input at a first display device via a network, and responsive to the first display device receiving the audio input, providing a fire only display via the first display device that is coordinated to the audio input, wherein a second device connected to the network only provides an audio output responsive to receiving the audio input. In a first example of the method, the audio input received at the first device is the same audio input that is received at the second device. In a second example of the method, optionally including the first example, the audio input is received from a hub. In a third example of the method, optionally including one or both of the first and second examples, the audio input is part of a display request input to the hub. In a fourth example of the method, optionally including one or more or each of the first through third examples, the audio input is received as part of a command for a display, and wherein the first display device converts the command into signals that are based on the first display device being a fire only display and that are based on the audio input. The disclosure also provides support for a method for operating a multi-media display, comprising: providing a command to different types of display devices on a network, converting the command at each of the display devices into signals according to display device type, and actuating the different types of display devices based on the signals. In a first example of the method, the command is provided in response to a display request received at a hub on the network. In a second example of the method, optionally including the first example, the different types of display devices include two or more of fire only devices, water devices, lighting devices, audio only devices, and combination fire and audio devices.

FIGS. 1-7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 1-7 are shown approximately to scale.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method, comprising:
communicatively connecting a central control hub of a first entertainment system to one or more display devices of a second entertainment system; and
actuating the one or more display devices of the second entertainment system via the central control hub.

2. The method of claim 1, wherein the first entertainment system and the second entertainment system are recreational vehicle (RV) entertainment systems.

3. The method of claim 1, wherein the one or more display devices include one or more of a water device, a fire device, a lighting device, a camera, and an audio device.

4. The method of claim 1, further comprising actuating one or more display devices of the first entertainment system via the central control hub.

5. The method of claim 1, wherein the central control hub is a first central control hub, and wherein the second entertainment system comprises a second central control hub.

6. The method of claim 5, wherein the one or more display devices of the second entertainment system are assigned to the second central control hub, and wherein the first entertainment system comprises one or more display devices assigned to the first central control hub.

7. The method of claim 5, wherein a communicative connection is established via satellite internet.

8. A method, comprising:
detecting a request to operate both a first entertainment system and one or more additional entertainment systems in a party mode;
communicatively connecting a first central control hub of the first entertainment system to the one or more additional entertainment systems; and
actuating one or more display devices of the first entertainment system and the one or more additional entertainment systems via the first central control hub.

9. The method of claim 8, wherein communicatively connecting the first central control hub to the one or more additional entertainment systems includes enabling the first central control hub to actuate devices of the first entertainment system and the one or more additional entertainment systems.

10. The method of claim 8, wherein the first entertainment system and the one or more additional entertainment systems comprise different types of devices.

11. The method of claim 10, wherein the different types of devices include two or more of fire devices, water devices, audio devices, and lighting devices.

12. The method of claim 9, further comprising, via the first central control hub, actuating at least one device from the one or more additional entertainment systems via a common control signal.

13. The method of claim 12, further comprising, via the first central control hub, actuating at least one device of the first entertainment system.

14. The method of claim 13, wherein a common signal is used to actuate the at least one device from the one or more additional entertainment systems and the at least one device of the first entertainment system in a coordinated manner.

15. The method of claim 12, wherein the at least one device from the one or more additional entertainment systems and the at least one device of the first entertainment system comprise different types of devices.

16. The method of claim 14, wherein the common signal is converted once received at the at least one device from the one or more additional entertainment systems and the at least one device of the first entertainment system.

17. The method of claim 8, wherein devices of the first entertainment system are assigned to the first central control hub, wherein each of the one or more additional entertainment systems comprises a corresponding central control hub, and wherein devices of each of the one or more additional entertainment systems are assigned to the corresponding central control hub.

18. The method of claim 8, wherein first entertainment system and the one or more additional entertainment systems are RV entertainment systems.

19. A system, comprising:
a central control hub;
one or more devices of a first entertainment system assigned to the central control hub;
one or more devices of a second entertainment system not assigned to the central control hub; and
instructions stored in non-transitory memory of the central control hub that are executable to:
during operation of the central control hub in a party mode, communicatively connect the central control hub to the one or more devices of the second entertainment system, and
actuate the one or more devices of the first entertainment system and actuate the one or devices of the second entertainment system via the central control hub.

20. The system of claim 19, wherein the instructions are further executable to:
during operation of the central control hub in a standard mode,
only actuate the one or more devices of the first entertainment via the central control hub, and
not actuate the one or more devices of the second entertainment system via the central control hub.
